(19) United States
(12) Patent Application Publication
(10) Pub. No.: US 2025/0045609 A1
(43) Pub. Date: Feb. 6, 2025

(54) SYSTEMS AND METHODS FOR GRADIENT ESTIMATION IN OPTIMIZATION TO IMPROVE COMPUTATIONAL EFFICIENCY FOR QUANTUM SYSTEMS

(71) Applicant: 1372934 B.C. Ltd., Burnaby (CA)

(72) Inventor: Hossein Sadeghi Esfahani, Vancouver (CA)

(21) Appl. No.: 18/609,874

(22) Filed: Mar. 19, 2024

Related U.S. Application Data
(60) Provisional application No. 63/453,522, filed on Mar. 21, 2023.

(51) Int. Cl. G06N 7/01

(52) U.S. Cl. CPC G06N 7/01

(57) ABSTRACT

Quantum-classical gradient estimation is described for use in determining a value of at least one optimizable parameter of an objective function. An optimization method can be performed by a digital processor coupled to an analog processor and can include, until the objective function converges: obtaining a set of samples generated by the analog processor; estimating a gradient of the objective function based on a current value of the at least one optimizable parameter and the set of samples; determining first and second order moments based on the estimated gradient, and, updating the optimizable parameters based on the moments. A method to train a machine learning data can include: receiving a training data set; generating a training model having an objective function; performing acts of the optimization method to optimize parameters of the training model; and, returning the optimized training model to the machine learning model.

### FIELD

This disclosure generally relates to systems and methods to optimize parameter values of an objective function, and, more specifically, to hybrid computing systems and quantum-classical methods to optimize one or more parameters of an objective function.

### BACKGROUND

### Quantum Devices

Quantum devices are structures in which quantum mechanical effects are observable. Quantum devices include circuits in which current transport is dominated by quantum mechanical effects. Such devices include spintronics, and superconducting circuits. Both spin and superconductivity are quantum mechanical phenomena. Quantum devices can be used as measurement instruments, in computing machinery, and the like.

### Quantum Computation

A quantum computer is a system that makes direct use of at least one quantum-mechanical phenomenon, such as superposition, tunneling, and entanglement, to perform operations on data. The elements of a quantum computer are qubits. Quantum computers can provide speedup for certain classes of computational problems such as computational problems simulating quantum physics.

### Superconducting Qubits

Superconducting qubits are solid state qubits based on circuits of superconducting materials. Operation of superconducting qubits is based on the underlying principles of magnetic flux quantization, and Josephson tunneling. Superconducting effects can be present in different configurations, and can give rise to different types of superconducting qubits including flux, phase, charge, and hybrid qubits. The different configurations can vary in the topology of the loops, the placement of the Josephson junctions, and the physical parameters of elements of the superconducting circuits, such as inductance, capacitance, and Josephson junction critical current.

### Hybrid Computing System Comprising a Quantum Processor

A hybrid computing system can include a digital computer communicatively coupled to an analog computer. In some implementations, the analog computer is a quantum computer, and the digital computer is a classical computer.

The digital computer can include a digital processor that can be used to perform classical digital processing tasks described in the present systems and methods. The digital computer can include at least one system memory that can be used to store various sets of computer- or processor-readable instructions, application programs and/or data.

The quantum computer can include a quantum processor that includes programmable elements such as qubits, couplers, and other devices. The qubits can be read out via a readout system, and the results communicated to the digital computer. The qubits and the couplers can be controlled by a qubit control system and a coupler control system, respectively. In some implementations, the qubit and the coupler control systems can be used to implement quantum annealing or gate model quantum computing on the analog computer.

### Quantum Processor

A quantum processor may take the form of a superconducting quantum processor. A superconducting quantum processor may include a number of superconducting qubits and associated local bias devices. A superconducting quantum processor may also include couplers (also known as coupling devices) that selectively provide communicative coupling between qubits.

In one implementation, the superconducting qubit includes a superconducting loop interrupted by a Josephson junction. The ratio of the inductance of the Josephson junction to the geometric inductance of the superconducting loop can be expressed as 2πLI_{C}/Φ₀ (where L is the geometric inductance, I_{C} is the critical current of the Josephson junction, and Do is the flux quantum). The inductance and the critical current can be selected, adjusted, or tuned, to increase the ratio of the inductance of the Josephson junction to the geometric inductance of the superconducting loop, and to cause the qubit to be operable as a bistable device. In some implementations, the ratio of the inductance of the Josephson junction to the geometric inductance of the superconducting loop of a qubit is approximately equal to three.

In one implementation, the superconducting coupler includes a superconducting loop interrupted by a Josephson junction. The inductance and the critical current can be selected, adjusted, or tuned, to decrease the ratio of the inductance of the Josephson junction to the geometric inductance of the superconducting loop, and to cause the coupler to be operable as a monostable device. In some implementations, the ratio of the inductance of the Josephson junction to the geometric inductance of the superconducting loop of a coupler is approximately equal to, or less than, one.

Further details and embodiments of example quantum processors that may be used in conjunction with the present systems and devices are described in U.S. Pat. Nos. 7,533,068; 8,008,942; 8,195,596; 8,190,548; and, 8,421,053.

### Adiabatic Quantum Computation

A Hamiltonian is an operator whose eigenvalues are the allowed energies of the system. Adiabatic quantum computation can include evolving a system from an initial Hamiltonian to a final Hamiltonian by a gradual change. One example of adiabatic evolution is a linear interpolation between the initial Hamiltonian Hᵢ and the final Hamiltonian H_{f}, as follows:

$${H}_{e} = ( 1 - s ) {H}_{i} + {sH}_{f} \qquad ( 1 )$$

where Hₑ is the evolution, or instantaneous, Hamiltonian, and s is an evolution coefficient that can control the rate of evolution.

As the system evolves, the evolution coefficient s changes value from 0 to 1. At the start, the evolution Hamiltonian Hₑ is equal to the initial Hamiltonian Hᵢ, and, at the end, the evolution Hamiltonian Hₑ is equal to the final Hamiltonian H_{f}.

The system is typically initialized in a ground state of the initial Hamiltonian Hᵢ, and the goal of the adiabatic evolution is to evolve the system such that it ends up in a ground state of the final Hamiltonian H_{f} at the end of the evolution. If the evolution is too fast, then the system can transition to a higher energy state of the system, such as the first excited state.

The method of changing the Hamiltonian in adiabatic quantum computing may be referred to as evolution. An adiabatic evolution is an evolution that satisfies an adiabatic condition such as:

$$\dot{s} \vert 〈 1 \vert {dH}_{e} / ds \vert 0 〉 \vert = δ {g}^{2} ( s ) \qquad ( 2 )$$

where \dot{s} is the time derivative of s, g(s) is the difference in energy between the ground state and first excited state of the system (also referred to herein as the gap size) as a function of s, and δ is a coefficient and δ<<1.

If the rate of change (for example, s), is slow enough that the system is always in the instantaneous ground state of the evolution Hamiltonian, then transitions at anti-crossings (i.e., when the gap size is smallest) are avoided. Equation (1) above is an example of a linear evolution schedule. Other evolution schedules can be used, including non-linear, parametric, and the like. Further details on adiabatic quantum computing systems, methods, and apparatus are described in, for example, U.S. Pat. Nos. 7,135,701 and 7,418,283.

### Quantum Annealing

Quantum annealing is a computational method that may be used to find a low-energy state of a system, typically preferably the ground state of the system. Similar in concept to classical simulated annealing, the method relies on the underlying principle that natural systems tend towards lower energy states because lower energy states are more stable. While classical annealing uses classical thermal fluctuations to guide a system to a low-energy state, quantum annealing may use quantum effects, such as quantum tunneling, as a source of delocalization to reach an energy minimum more accurately and/or more quickly than classical annealing.

A quantum processor may be designed to perform quantum annealing and/or adiabatic quantum computation. An evolution Hamiltonian can be constructed that is proportional to the sum of a first term proportional to a problem Hamiltonian and a second term proportional to a delocalization Hamiltonian, as follows:

$${H}_{E} ∝ A ( t ) {H}_{P} + B ( t ) {H}_{D}$$

where H_{E} is the evolution Hamiltonian, Hp is the problem Hamiltonian, H_{D} is the delocalization Hamiltonian, and A(t), B(t) are coefficients that can control the rate of evolution, and typically lie in the range [0,1].

In some implementations, a time varying envelope function can be placed on the problem Hamiltonian. A suitable delocalization Hamiltonian is given by:

$${H}_{D} ∝ - \frac{1}{2} {\sum }_{i = 1}^{N} {Δ}_{i} {σ}_{i}^{x}$$

where N represents the number of qubits, σᵢ^{x} is the Pauli x-matrix for the i^{th} qubit and Δᵢ is the single qubit tunnel splitting induced in the i^{th} qubit. Here, the ox terms are examples of “off-diagonal” terms.

A common problem Hamiltonian includes a first component proportional to diagonal single qubit terms and a second component proportional to diagonal multi-qubit terms, and may be of the following form:

$${H}_{P} ∝ - \frac{ε}{2} [ {\sum }_{i = 1}^{N} {h}_{i} {σ}_{i}^{z} + {\sum }_{j > i}^{N} {J}_{ij} {σ}_{i}^{z} {σ}_{j}^{z} ]$$

where N represents the number of qubits, σᵢ^{z} is the Pauli z-matrix for the i^{th} qubit, hᵢ and Jᵢⱼ are dimensionless local fields for the qubits, and couplings between qubits, and & is some characteristic energy scale for Hp.

Here, the σᵢ^{z} and σᵢ^{z}σⱼ^{z} terms are examples of “diagonal” terms. The former is a single qubit term and the latter a two qubit term.

Throughout this specification, the terms “problem Hamiltonian” and “final Hamiltonian” are used interchangeably unless the context dictates otherwise. Certain states of the quantum processor are, energetically preferred, or simply preferred by the problem Hamiltonian. These include the ground states but may include excited states.

Hamiltonians such as Hp and Hp in the above two equations, respectively, may be physically realized in a variety of different ways. A particular example is realized by an implementation of superconducting qubits.

### Sampling

Throughout this specification and the appended claims, the terms “sample”, “sampling”, “sampling device”, and “sample generator” are used. These terms are used herein in like manner to their corresponding uses in the arts of statistics and statistical analysis, and electrical engineering.

In statistics, a sample is a subset of a population, i.e., a selection of data taken from a statistical population. Sampling is the method of taking the sample, and typically follows a defined procedure. For example, in a population, database, or collection of objects, a sample may refer to an individual datum, data point, object, or subset of data, data points, and/or objects.

In electrical engineering and related disciplines, sampling relates to taking a set of measurements of an analog signal or some other physical system. Sampling may include conversion of a continuous signal to a discrete signal.

In many fields, including simulations of physical systems, and computing, especially analog computing, the foregoing meanings may merge. For example, a hybrid computer can draw samples from an analog computer. The analog computer, as a provider of samples, is an example of a sample generator. The analog computer can be operated to provide samples from a selected probability distribution, the probability distribution assigning a respective probability of being sampled to each data point in the population.

An analog processor, for example a quantum processor and in particular a quantum processor designed to perform quantum annealing and/or adiabatic quantum computation, may be operated as a sample generator. The population can correspond to all possible states of the processor, and each sample can correspond to a respective state of the processor. Using an analog processor as a sample generator may be a preferred mode of operating the processor for certain applications. Operating an analog processor as a sample generator may also enable a broader range of problems to be solved compared to, for example, using an analog processor to find a low energy state of a Hamiltonian that encodes an optimization problem.

### Machine Learning

Machine learning relates to methods and circuitry that can learn from data and make predictions based on data. In contrast to methods or circuitry that follow static program instructions, machine learning methods and circuitry can include deriving a model from example inputs (such as a training set) and then making data-driven predictions.

Machine learning is related to optimization. Some problems can be expressed in terms of minimizing a loss function on a training set, where the loss function describes the disparity between the predictions of the model being trained and observable data.

Machine learning tasks can include unsupervised learning, supervised learning, and reinforcement learning. Approaches to machine learning include, but are not limited to, decision trees, linear and quadratic classifiers, case-based reasoning, Bayesian statistics, and artificial neural networks.

Machine learning can be used in situations where explicit approaches are considered infeasible. Example application areas include optical character recognition, search engine optimization, and computer vision.

### Boltzmann Machines

A Boltzmann machine is an implementation of a probabilistic graphical model that includes a graph with undirected weighted edges between vertices. The vertices (also called units) follow stochastic decisions about whether to be in an “ON” state or an “OFF” state. The stochastic decisions are based on the Boltzmann distribution. Each vertex has a bias associated with the vertex. Training a Boltzmann machine includes determining the weights and the biases.

Boltzmann machines can be used in machine learning because they can follow simple learning procedures. For example, the units in a Boltzmann machine can be divided into visible units and hidden units. The visible units are visible to the outside world, can be divided into input units and output units. The hidden units are hidden from the outside world. There can be more than one layer of hidden units. If a user provides a Boltzmann machine with a plurality of vectors as input, the Boltzmann machine can determine the weights for the edges, and the biases for the vertices, by incrementally adjusting the weights and the biases until the machine is able to generate the plurality of input vectors with high probability. In other words, the machine can incrementally adjust the weights and the biases until the marginal distribution over the variables associated with the visible units of the machine matches an empirical distribution observed in the outside world, or at least, in the plurality of input vectors.

In a Restricted Boltzmann Machine, there are no intra-layer edges (or connections) between units. In the case of a RBM comprising a layer of visible units and a layer of hidden units, there are no edges between the visible units, and no edges between the hidden units.

The edges between the visible units and the hidden units can be complete (i.e., fully bipartite) or less dense.

### Generative and Discriminative Models

Generative learning and discriminative learning are two categories of approaches to machine learning. Generative approaches are based on models for a joint probability distribution over the observed and the target variables, whereas discriminative approaches are based on models for a conditional probability of the target variables given the observed variables.

The foregoing examples of the related art and limitations related thereto are intended to be illustrative and not exclusive. Other limitations of the related art will become apparent to those of skill in the art upon a reading of the specification and a study of the drawings.

### BRIEF SUMMARY

Solving optimization problems often includes calculation of a gradient of an objective function of the problem, but gradient calculation can be non-trivial, and convergence of the objective function can be time and resource intensive, and/or not provide most accurate results. Simultaneous perturbation stochastic approximation can be used to estimate a gradient using two evaluations of the objective function to speed up gradient calculation. However, this method decreases in efficacy when used to optimize problems with many parameters. This gradient estimation can be used in determining of first and second order moment updates, which can accelerate optimization in a direction of an extremum (i.e., a maximum or minimum) and mitigate effects of noisy steps in undesired directions.

A stochastic gradient-based optimization with an adaptive learning rate addresses several shortcomings of gradient-descent based optimization techniques, and can nearly track an actual gradient path due to the small bias of random directions obtained in software for simultaneous perturbation of the objection function. Still, bias can be removed by obtaining truly random values to determine random directions instead of pseudo-random samples from software.

There exists a need for an efficient optimization technique that does not include calculating gradients and can accurately estimate gradients of an objective function. To converge more quickly, gradient estimation can use truly random samples having reduced or nearly eliminated bias, which can be generated by a quantum processor from a known probability distribution. The optimization technique can be used to quickly and accurately train a machine learning model.

In an aspect, there is a method to optimize one or more optimizable parameters of a model that is performed by at least one digital processor communicatively coupled to a quantum processor. The method includes initializing a set of parameters including the one or more optimizable parameters and an objective function. Until the objective function converges, the method includes: receiving, by the at least one digital processor, a set of samples from a probability distribution generated by the quantum processor; estimating, by the at least one digital processor, a gradient of the objective function based on a current value of the at least one optimizable parameter and the set of samples from the probability distribution generated by the quantum processor; determining, by the at least one digital processor, first and second order moments based on the estimated gradient; updating, by the at least one digital processor, the one or more optimizable parameters based on the first and the second order moments; and, evaluating, by the at least one digital processor, the objective function using updated values of the one or more optimizable parameters.

In some implementations, estimating the gradient based on the current value of the at least one optimizable parameter and the set of samples from the probability distribution generated by the quantum processor includes: generating an array of random directions based on the set of samples generated from the probability distribution by the quantum processor; and, estimating the gradient based on the current value of the at least one optimizable parameter and the array of random directions.

In some implementations, estimating the gradient based on the current value of the at least one optimizable parameter and the set of samples from the probability distribution generated by the quantum processor includes: evaluating the objective function with the current value of the at least one optimizable parameter perturbed by a perturbation parameter in a first direction to obtain a first objective function value; evaluating the objective function with the current value of the at least one optimizable parameter perturbed by the perturbation parameter in a second direction that opposes the first direction to obtain a second objective function value; and, determining a rate of change between the first and the second objective function values.

In some implementations, evaluating the objective function with the current value of the at least one optimizable parameter perturbed by the perturbation parameter includes: determining the perturbation parameter based on a normalized perturbation strength and the set of samples from the probability distribution generated by the quantum processor.

In some implementations, initializing the set of parameters includes receiving an initial perturbation strength. Determining the perturbation parameter based on the normalized perturbation strength and the set of samples generated by the quantum processor includes determining the normalized perturbation strength based on the initial perturbation strength and a current perturbation strength decay.

In some implementations, prior to receiving, by the at least one digital processor, a set of samples from a probability distribution generated by the quantum processor, the method includes: instructing the quantum processor to generate the set of samples from the probability distribution.

In some implementations, the quantum processor comprises a plurality of qubits. Instructing the quantum processor to generate the set of samples from the probability distribution include: programming the quantum processor to have the probability distribution over the plurality of qubits, and instructing the quantum processor to perform quantum evolution using the plurality of qubits. Receiving, by the at least one digital processor, a set of samples from a probability distribution generated by the quantum processor includes: receiving a set of states of the plurality of qubits observable after quantum evolution that correspond to samples from the probability distribution.

In some implementations, receiving, by the at least one digital processor, a set of samples from a probability distribution generated by the quantum processor includes: receiving a set of samples from a symmetric, zero mean probability distribution that satisfies an inverse moment bound.

In an aspect, there is a method to train a machine learning model performed by at least one digital processor communicatively coupled to a quantum processor. The method includes: receiving a training data set; generating a training model associated with the machine learning model, the training model having an objective function; initializing training model parameters, the training model parameters including at least one optimizable parameter of the machine learning model; receiving, from the quantum processor, a set of samples from a probability distribution generated by the quantum processor; using the training model, by the at least one digital processor, to optimize the at least one optimizable parameter of the machine learning model, which includes estimating a gradient of the objective function using a current value of the at least one optimizable parameter and a perturbation parameter based on the set of samples generated by the quantum processor; and, returning, to the machine learning model, the training model with an optimized value of the at least one optimizable parameter.

In some implementations, using the training model to optimize the at least one optimizable parameter of the machine learning model further includes: determining a first order moment and a second order moment using the gradient of the objective function that is estimated based on the set of samples from the probability distribution generated by the quantum processor; determining an updated value of the at least one optimizable parameter of the training model based on the first order moment and the second order moment; and, evaluating the objective function using the updated value of the at least one optimizable parameter. Returning, to the machine learning model, the training model with the optimized value of the at least one optimizable parameter includes: returning the updated value of the at least one optimizable parameter once the objective function converges.

In some implementations, estimating the gradient of the objective function based on the current value of the at least one optimizable parameter and the perturbation parameter based on the set of samples generated by the quantum processor includes: evaluating the objective function with the current value of the at least one optimizable parameter perturbed by the perturbation parameter in a first direction to obtain a first objective function value; evaluating the objective function with the current value of the at least one optimizable parameter perturbed the perturbation parameter in a second direction that opposes the first direction to obtain a second objective function value; and determining a rate of change between the first and the second objective function values.

In some implementations, using the training model to optimize the at least one optimizable parameter of the machine learning model includes determining a value of the perturbation parameter. The determining the value of the perturbation parameter includes: generating an array of random directions using the set of samples generated by the quantum processor as an array of random binary variables; and, determining a normalized perturbation strength. The perturbation parameter is a product of the array of random directions and the normalized perturbation strength.

In some implementations, generating a training model associated with the machine learning model includes generating at least a training model associated with a generative machine learning model.

In some implementations, generating a training model includes generating a quantum Boltzmann machine.

In some implementations, generating a training model includes generating a model described by a transverse Ising Hamiltonian, and the at least one optimizable parameter includes at least one Hamiltonian parameter.

In some implementations, the objective function is a loss function, and using the training model to optimize the at least one optimizable parameter of the machine learning model includes minimizing the loss function describing a difference between data belonging to the training data set and the set of samples. Estimating a gradient of the objective function includes estimating a gradient of the loss function.

In some implementations, prior to receiving, by the at least one digital processor, a set of samples from a probability distribution generated by the quantum processor, the method includes: instructing the quantum processor to generate the set of samples from the probability distribution.

In some implementations, the quantum processor includes a plurality of qubits. Instructing the quantum processor to generate the set of samples from the probability distribution includes: programming the quantum processor to have the probability distribution over the plurality of qubits, and instructing the quantum processor to perform quantum evolution using the plurality of qubits. Receiving, by the at least one digital processor, a set of samples having a probability distribution generated by the quantum processor includes: receiving a set of states of the plurality of qubits observable after quantum evolution that correspond to samples from the probability distribution.

In some implementations, receiving, from the quantum processor, a set of samples from a probability distribution generated by the quantum processor includes receiving, from the quantum processor, samples from a symmetric, zero mean probability distribution that satisfies an inverse moment bound.

In some implementations, receiving, from the quantum processor, a set of samples from a probability distribution generated by the quantum processor includes receiving samples obtained in a coherent regime when the quantum processor exhibits non-equilibrium dynamics.

In an aspect, there is a system to perform machine learning the system including: at least one digital processor communicatively coupled to a quantum processor; and at least one non-transitory processor-readable medium communicatively coupled to the at least one digital processor. The at least one non-transitory processor-readable medium stores at least one of processor-executable instructions or data which, when executed by the at least one digital processor, cause the at least one digital processor to: initialize a set of parameters, including one or more optimizable parameters and an objective function, and, until the objective function converges: receive, by the at least one digital processor a set of samples from a probability distribution generated by the quantum processor; estimate, by the at least one digital processor, a gradient of the objective function based on a current value of the at least one optimizable parameter and the set of samples from the probability distribution generated by the quantum processor; determine, by the at least one digital processor, first and second order moments based on the estimated gradient; evaluate, by the at least one digital processor, the objective function using updated values of the one or more optimizable parameters; and, update, by the at least one digital processor, the one or more optimizable parameters based on the first and the second order moments.

In some implementations, the quantum processor comprises a plurality of qubits.

In some implementations, each sample of the set of samples is a set of states of the plurality of qubits of the quantum processor.

In some implementations, the quantum processor is a quantum annealer or an adiabatic quantum processor.

In some implementations, the gradient is based on the current value of the at least one optimizable parameter and an array of random directions, and the array of random directions is based on the set of samples generated by the quantum processor.

In some implementations, the gradient is based on a rate of change between a first objective function value and a second objective function value. The first objective function value is an evaluation of the objective function at the current value of the at least one optimizable parameter perturbed by a perturbation parameter in a first direction. The second objective function value is an evaluation of the objective function at the current value of the at least one optimizable parameter perturbed by the perturbation parameter in a second direction that opposes the first direction.

In some implementations, the perturbation parameter is based on a normalized perturbation strength and the set of samples generated by the quantum processor.

In some implementations, the normalized perturbation strength based on a perturbation strength and a current perturbation strength decay.

In some implementations, the set of samples generated by the quantum processor are samples from a symmetric, zero mean probability distribution that satisfies an inverse moment bound.

In some implementations, the set of samples generated by the quantum processor are samples obtained when the quantum processor exhibits non-equilibrium dynamics in a coherent regime.

In some implementations, prior to receipt of the set of samples from the quantum processor, the at least one digital processor is to instruct the quantum processor to generate the set of samples from the probability distribution.

In an aspect, there is a system to perform machine learning the system comprising: at least one digital processor communicatively coupled to a quantum processor and at least one non-transitory processor-readable medium communicatively coupled to the at least one digital processor. The at least one non-transitory processor-readable medium stores at least one of processor-executable instructions or data which, when executed by the at least one digital processor, cause the at least one digital processor to: receive a training data set; generate a training model associated with the machine learning model, the training model having an objective function; initialize training model parameters, the training model parameters including at least one optimizable parameter of the machine learning model; receive, from the quantum processor, a set of samples from a probability distribution generated by the quantum processor; use the training model to optimize the at least one optimizable parameter of the machine learning model, in which using the training model includes estimating a gradient of the objective function using a current value of the at least one optimizable parameter and a perturbation parameter based on the set of samples generated by the quantum processor; and, return, to the machine learning model, the training model with an optimized value of the at least one optimizable parameter.

### BRIEF DESCRIPTION OF THE SEVERAL VIEWS OF THE DRAWING(S)

In the drawings, identical reference numbers identify similar elements or acts. The sizes and relative positions of elements in the drawings are not necessarily drawn to scale. For example, the shapes of various elements and angles are not necessarily drawn to scale, and some of these elements may be arbitrarily enlarged and positioned to improve drawing legibility. Further, the particular shapes of the elements as drawn, are not necessarily intended to convey any information regarding the actual shape of the particular elements, and may have been solely selected for ease of recognition in the drawings.

FIG. 1 is a schematic diagram of a hybrid computing system including a digital computer coupled to an analog computer, in accordance with the present systems, devices, and methods.

FIG. 2 is a schematic diagram of a circuit of an example superconducting quantum processor, in accordance with the present systems, devices, and methods.

FIG. 3 is a flow diagram of a method to optimize an objective function, in accordance with the present systems, devices, and methods.

FIG. 4 is a flow diagram of a hybrid computing method to optimize parameters of an objective function, in accordance with the present systems, devices, and methods.

FIG. 5 is a schematic diagram of a system to optimize an objective function, in accordance with the present systems, devices, and methods.

FIG. 6 is a flow diagram of a method to train a quantum-classical machine learning model, in accordance with the present systems, devices, and methods.

### DETAILED DESCRIPTION

### Preamble

In the following description, certain specific details are set forth in order to provide a thorough understanding of various disclosed implementations. However, one skilled in the relevant art will recognize that implementations may be practiced without one or more of these specific details, or with other methods, components, materials, etc. In other instances, well-known structures associated with computer systems, server computers, and/or communications networks have not been shown or described in detail to avoid unnecessarily obscuring descriptions of the implementations.

Unless the context requires otherwise, throughout the specification and claims that follow, the word “comprising” is synonymous with “including,” and is inclusive or open-ended (i.e., does not exclude additional, unrecited elements or method acts).

Reference throughout this specification to “one implementation” or “an implementation” means that a particular feature, structure or characteristic described in connection with the implementation is included in at least one implementation. Thus, the appearances of the phrases “in one implementation” or “in an implementation” in various places throughout this specification are not necessarily all referring to the same implementation. Furthermore, the particular features, structures, or characteristics may be combined in any suitable manner in one or more implementations.

As used in this specification and the appended claims, the singular forms “a,” “an,” and “the” include plural referents unless the context clearly dictates otherwise. It should also be noted that the term “or” is generally employed in its sense including “and/or” unless the context clearly dictates otherwise.

As used in this specification and the appended claims, the term “optimized solution” does not necessarily mean the “optimal solution”, but rather refers to a best solution of a set of solutions, for instance for a given iteration.

The headings and Abstract of the Disclosure provided herein are for convenience only and do not interpret the scope or meaning of the implementations.

### Example Hybrid Computing System

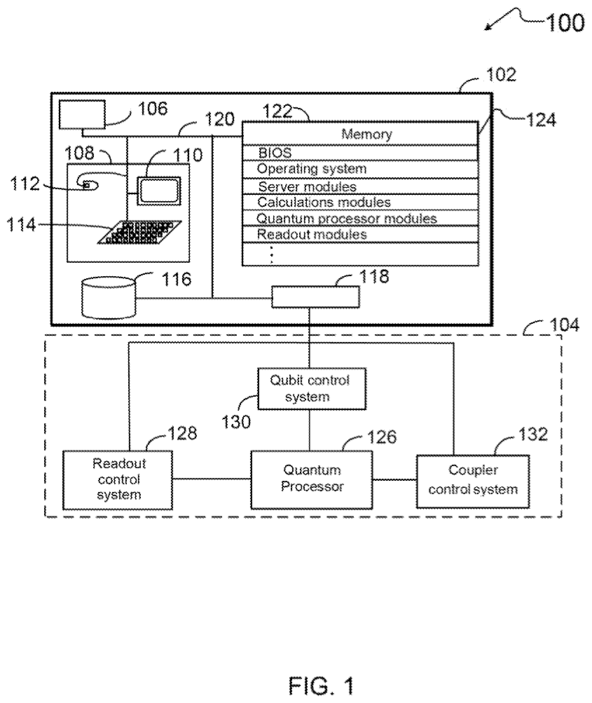

FIG. 1 illustrates a computing system 100 comprising a digital computer 102. The example digital computer 102 includes one or more digital processors 106 that may be used to perform classical digital processing tasks. Digital computer 102 may further include at least one system memory 122, and at least one system bus 120 that couples various system components, including system memory 122 to digital processor(s) 106. At least one system memory 122 may store one or more sets of processor-executable instructions, which may be referred to as modules 124.

Digital processor(s) 106 may be any logic processing unit or circuitry (for example, integrated circuits), such as one or more central processing units (“CPUs”), graphics processing units (“GPUs”), digital signal processors (“DSPs”), application-specific integrated circuits (“ASICs”), programmable gate arrays (“FPGAs”), programmable logic controllers (“PLCs”), etc., and/or combinations of the same. Digital processor(s) 106 can be operated at room temperatures, or cooled below room temperatures, or even cooled and operated at cryogenic temperatures.

In some implementations, computing system 100 comprises an analog computer 104, which may include one or more quantum processors 126. Quantum processor 126 may include at least one superconducting integrated circuit. Digital computer 102 may communicate with analog computer 104 via, for instance, a controller 118. Certain computations may be performed by analog computer 104 at the instruction of digital computer 102, as described in greater detail herein. Quantum processor(s) 126 can comprise materials that exhibit superconductive behavior at and below a critical temperature, and quantum processor(s) 126 be cooled and operated at and below said critical temperature.

Digital computer 102 may include a user input/output subsystem 108. In some implementations, the user input/output subsystem 108 includes one or more user input/output components such as a display 110, a mouse 112, and/or a keyboard 114.

System bus 120 may employ any known bus structures or architectures, including a memory bus with a memory controller, a peripheral bus, and a local bus. System memory 122 may include non-volatile memory, such as read-only memory (“ROM”), static random-access memory (“SRAM”), Flash NAND; and volatile memory such as random-access memory (“RAM”).

Digital computer 102 may also include other non-transitory computer- or processor-readable storage media or non-volatile memory 116. Non-volatile memory 116 may take a variety of forms, including: a hard disk drive for reading from and writing to a hard disk (for example, a magnetic disk), an optical disk drive for reading from and writing to removable optical disks, and/or a solid state drive (SSD) for reading from and writing to solid state media (for example NAND-based Flash memory). Non-volatile memory 116 may communicate with digital processor(s) 106 via system bus 120 and may include appropriate interfaces or controllers 118 coupled to system bus 120. Non-volatile memory 116 may serve as long-term storage for processor- or computer-readable instructions, data structures, or other data (sometimes called program modules or modules 124) for digital computer 102.

Although digital computer 102 has been described as employing hard disks, optical disks and/or solid-state storage media, those skilled in the relevant art will appreciate that other types of non-transitory and non-volatile computer-readable media may be employed. Those skilled in the relevant art will appreciate that some computer architectures employ non-transitory volatile memory and non-transitory non-volatile memory. For example, data in volatile memory may be cached to non-volatile memory or a solid-state disk that employs integrated circuits to provide non-volatile memory.

Various processor- or computer-readable and/or executable instructions, data structures, or other data may be stored in system memory 122. For example, system memory 122 may store executable instructions to provide communications with remote clients and scheduling use of resources including resources on the digital computer 102 and analog computer 104. Also, for example, system memory 122 may store at least one of processor executable instructions or data that, when executed by at least one processor, causes the at least one processor to execute the various algorithms to execute instructions. In some implementations system memory 122 may store processor- or computer-readable calculation instructions and/or data to perform pre-processing, co-processing, and post-processing to analog computer 104. System memory 122 may store a set of analog computer interface instructions to interact with analog computer 104. For example, the system memory 122 may store processor- or computer-readable instructions, data structures, or other data which, when executed by a processor or computer causes the processor(s) or computer(s) to execute one, more or all of the acts of the methods described herein.

Analog computer 104 may include at least one analog processor, such as quantum processor 126. Analog computer 104 may be provided in an isolated environment, for example, in an isolated environment that shields the internal elements of the quantum computer from heat, magnetic field, and other external noise. The isolated environment may include a refrigerator, for instance a dilution refrigerator, operable to cryogenically cool the analog processor, for example to temperature below approximately 1 K.

Analog computer 104 may include programmable elements such as qubits, couplers, and other devices (also referred to herein as: “controllable devices”). Qubits may be read out via a readout control system 128. Readout results may be sent to other computer- or processor-readable instructions of digital computer 102. Qubits may be controlled via a qubit control system 130. Qubit control system 130 may include on-chip Digital to Analog Converters (DACs) and analog lines that are operable to apply a bias to a target device. Couplers that couple qubits may be controlled via a coupler control system 132. Coupler control system 132 may include tuning elements such as on-chip DACs and analog lines.

In some implementations, qubit control system 130 and coupler control system 132 may be used to implement a quantum annealing schedule as described herein on analog computer 104 employing one or more analog processors. In accordance with some implementations of the present disclosure, a quantum processor, such as quantum processor 126, may be designed to perform quantum annealing and/or adiabatic quantum computation. Examples of quantum processors are described in U.S. Pat. No. 7,533,068.

Alternatively, a quantum processor, such as quantum processor 126, may be a universal quantum computer, and may be designed to perform universal adiabatic quantum computing, or other forms of quantum computation such as gate model-based quantum computation.

### Example Superconducting Quantum Processor

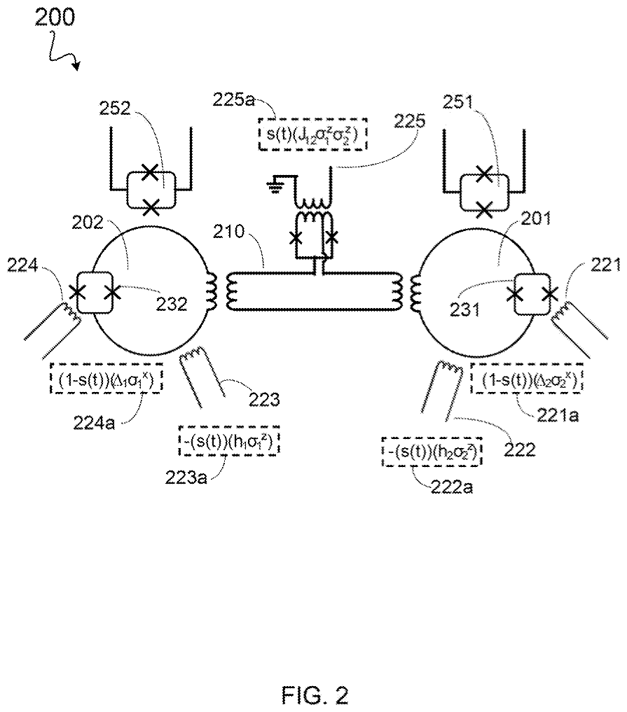

FIG. 2 is a schematic diagram of a circuit 200 of an example portion of a superconducting quantum processor, according to at least one implementation. The superconducting quantum processor to which circuit 200 belongs may be, for example, analog computer 104 that is included as part of computing system 100. This superconducting quantum processor may be used, for instance, to perform quantum annealing and/or adiabatic quantum computing.

Circuit 200 includes two superconducting qubits 201 and 202. Also shown is a tunable coupling provided by a coupler 210 between qubits 201 and 202 (i.e., providing 2-local interaction). While circuit 200 shown in FIG. 2 includes only two qubits 201, 202 and one coupler 210, those of skill in the art will appreciate that a superconducting quantum processor may include any number of qubits and any number of couplers coupling information between them.

Circuit 200 includes a plurality of interfaces 221, 222, 223, 224, 225 that are used to configure and control the state of the superconducting quantum processor. Each interface of plurality of interfaces 221-225 can be realized by a respective inductive coupling structure, as illustrated, as part of a programming subsystem and/or an evolution subsystem. Alternatively, or in addition, plurality of interfaces 221-225 may be realized by a galvanic coupling structure. In some implementations, one or more interfaces of plurality of interfaces 221-225 may be driven by one or more flux storage devices or DACs. Such a programming subsystem and/or evolution subsystem may be separate from the superconducting quantum processor, or may be included locally (i.e., on-chip with the superconducting quantum processor). For example, referring to computing system 100 of FIG. 1, locally included programming subsystem and/or optional evolution subsystem can be arranged as part of analog computer 104.

In the operation of the superconducting quantum processor, interfaces 221 and 224 can each be used to couple a flux signal into a respective compound Josephson junction (CJJ) 231 and 232, respectively, of qubits 201 and 202, thereby realizing a tunable tunneling term (the A; term) in the system Hamiltonian. This coupling provides the off-diagonal ox terms of the Hamiltonian and these flux signals are examples of “delocalization signals”. Examples of Hamiltonians (and their terms) used in quantum computing are described in greater detail in, for example, U.S. Pat. No. 9,424,526.

Similarly, interfaces 222 and 223 can each be used to apply a flux signal into a respective qubit loop of qubits 201 and 202, thereby realizing the hᵢ terms (dimensionless local fields for the qubits) in the system Hamiltonian. This coupling provides the diagonal σ^{z} terms in the system Hamiltonian. Furthermore, interface 225 may be used to couple a flux signal into coupler 210, thereby realizing the Jᵢⱼ term(s) (dimensionless local fields for the couplers) in the system Hamiltonian. This coupling provides the diagonal σᵢ^{z}σⱼ^{z} terms in the system Hamiltonian.

In FIG. 2, the contribution of each interface of plurality of interfaces 221-225 to the system Hamiltonian is indicated in broken line boxes 221a, 222a, 223a, 224a, 225a, respectively. As shown, in the example of FIG. 2, broken line boxes 221a-225a are elements of time-varying Hamiltonians for quantum annealing and/or adiabatic quantum computing.

Throughout this specification and the appended claims, the term: “quantum processor” is used to generally describe a collection of physical qubits (e.g., qubits 201 and 202) and qubit couplers (e.g., coupler 210). The physical qubits and the coupler are referred to as the “controllable devices” of a quantum processor and their corresponding parameters (e.g., the qubit hᵢ values and the coupler Jᵢⱼ values) are referred to as the “controllable parameters” of the quantum processor. In the context of a quantum processor, the term “programming subsystem” is used to generally describe the interfaces (e.g., “programming interfaces” 222, 223, and 225) used to apply the controllable parameters to the controllable devices of the superconducting quantum processor and other associated control circuitry and/or instructions. In some implementations, programming interfaces 222, 223, and 225 may be included as part of qubit control system 130 and coupler control system 132 that are part of analog computer 104 in FIG. 1. In some implementations, programming interfaces 222, 223, and 225 may include DACs. DACs may also be considered programmable devices that are used to control controllable devices such as qubits, couplers, and parameter tuning devices.

As previously described, the programming interfaces of the programming subsystem may communicate with other subsystems which may be separate from the quantum processor or may be included locally on the processor, such as arranged as part of analog computer 104 of FIG. 1. The programming subsystem may be configured to receive programming instructions in a machine language of the quantum processor and execute the programming instructions to program the programmable and controllable devices in accordance with the programming instructions. Similarly, in the context of a quantum processor that performs annealing and/or adiabatic quantum computation, the term “evolution subsystem” generally includes the interfaces (e.g., “evolution interfaces” 221 and 224) used to evolve devices such as the qubits of circuit 200 and other associated control circuitry and/or instructions. For example, the evolution subsystem may include analog signal lines and their corresponding interfaces (221, 224) to the qubits (201, 202). In some implementations, where the quantum processor is implemented as analog computer 104 of FIG. 1, the controllable devices may be arranged as part of quantum processor 126 and these other subsystems may be at least one of: readout control system 128, qubit control system 130, and coupler control system 132 of analog computer 104. The initial programming instructions may be provided using digital computer 102 and sent to the quantum processor and its corresponding subsystems through digital processor(s) 106.

Circuit 200 also includes readout devices 251 and 252, where readout device 251 is associated with qubit 201 and readout device 252 is associated with qubit 202. In the example implementation shown in FIG. 2, each of readout devices 251 and 252 includes a direct current superconducting quantum interference device (DC-SQUID) inductively coupled to the corresponding qubit. In the context of circuit 200, the term “readout subsystem” is used to generally describe the readout devices 251, 252 used to read out the final states of the qubits (e.g., qubits 201 and 202) in the superconducting quantum processor to produce a bit string. The readout subsystem may also include other elements, such as routing circuitry (e.g., latching elements, a shift register, or a multiplexer circuit) and/or may be arranged in alternative configurations (e.g., an XY-addressable array, an XYZ-addressable array, etc.), any of which may comprise DACs. Qubit readout may also be performed using alternative circuits, such as that described in U.S. Pat. No. 8,854,074. In some implementations, readout devices 251 and 252 and other elements of the readout subsystem in circuit 200 may form a portion of readout control system 128 in analog computer 104 of FIG. 1.

While FIG. 2 illustrates only two physical qubits 201, 202, one coupler 210, and two readout devices 251, 252, a quantum processor (e.g., processor comprising circuit 200) may employ any number of qubits, couplers, and/or readout devices, including a larger number (e.g., hundreds, thousands or more) of qubits, couplers and/or readout devices. The application of the teachings herein to processors with a different (e.g., larger) number of computational components should be readily apparent to those of ordinary skill in the art.

A superconducting quantum processor may include other types of qubits besides superconducting flux qubits. For example, a superconducting quantum processor may include superconducting charge qubits, transmon qubits, and the like.

Solving Optimization Problems without Calculating Gradients

Many problems that one may seek to solve involve optimization, such that an obtained solution provides the most efficient approach to carry out a particular action and/or achieve a particular goal. As well, training a machine learning model may include finding a maximum or minimum value of a prescribed objective function and/or minimizing a loss function indicative of differences between the model being trained and observable data.

Often, gradient descent-based algorithms are used to perform optimization. For instance, gradient descent may be used to maximize or minimize an objective function in view of model parameters by iteratively stepping in the opposite direction of the gradient of the objective function, and stepping in the direction of its steepest ascent or descent until reaching a respective maximum or minimum point. Variants of gradient descent include: batch gradient descent, which computes a gradient of the objective function for an entire training dataset; stochastic gradient descent, which performs a parameter value update for each training sample; and, mini-batch gradient descent, which performs a parameter value update for each mini-batch of training samples having a size n.

Several machine learning models use gradient calculations of gradient descent-based algorithms as part of performing optimization. Two such models include Boltzmann machines and Variational Auto-Encoders (VAEs). Boltzmann machines are typically trained using a gradient descent technique to minimize an upper bound for the log-likelihood of the conditional probability. For a detailed description of Boltzmann machines, see U.S. Pat. No. 11,062,227. VAEs are typically trained using an optimization of an objective function, which may include performing gradient descent to construct a stochastic approximation to a lower bound on the log-likelihood of the training data and/or a stochastic approximation to a gradient of the lower bound on the log-likelihood, which may be used to increase the lower bound on the log-likelihood. For a detailed description of VAEs, see US Patent Application Publication No. 2020/0401916.

Although several gradient descent-based algorithms have been developed and are known in the art, gradient descent-based algorithms are also subject to some undesirable limitations. Notably, there are some instances in which the use of gradient descent might not result in a model converging to an optimized solution (i.e., evaluations of the objective function trend toward, and stabilize near, an optimal value). Herein, the term: “optimized solution” can refer to an optimal solution or a near optimal solution. Batch gradient descent may result in a stable error gradient such that the model may return a local maximum or minimum instead of a universal maximum or minimum. For large data sets, the batch of training samples may be too large to store in memory of a classical computer and require a long processing time, such that additional resources may be needed. Stochastic gradient descent may include “noisy steps” that may lead the gradient in undesired directions and increase convergence time. As well, updating parameter values based on each sample is computationally expensive and thus resource intensive. Other challenges associated with gradient-based optimization include: selection of an appropriate learning rate, adjustment of a learning rate schedule, handling sparse data sets, and minimization of highly non-convex error functions.

Despite these shortcomings, optimization problems, such as the training of machine learning models, can be readily solved when gradients can be efficiently calculated. However, for functions for which calculation of a gradient is non-trivial or not possible, many known optimization techniques become either inefficient or unfeasible. Here, optimization techniques that do not involve gradient calculation are relied upon.

A naïve method of optimization without gradient calculation requires evaluation of a function of interest 2n+1 times, where n is indicative of a number of parameters in the function and the function may be an objective function or a loss function. Although this approach can result in an accurate estimate of a gradient, it requires performance of O(n) measurements and can be slow to converge. This is because a value of each parameter is perturbed separately to calculate its partial derivative.

Another method of optimization without calculating gradients is Simultaneous Perturbation Stochastic Approximation (SPSA). Unlike the above-noted naïve optimization method, SPSA perturbs values of multiple parameters at a same time, which thereby requires only two function evaluations at each update step. A detailed description of SPSA can be found in Spall (Spall, J. C. (1987), “A Stochastic Approximation Technique for Generating Maximum Likelihood Parameter Estimates,” Proceedings of the American Control Conference, Minneapolis, MN, June 1987, pp. 1161-1167). SPSA provides efficient optimization of functions having a range of 10 to 100 parameters, but decreases in efficiency when a number of parameters exceeds 100. As the number of parameters over 100 increases, SPSA suffers from many of the same limitations as stochastic gradient descent. For instance, the calculated random direction (or “noisy steps”) might not provide the desired descent Reducing a step size of the algorithm to improve performance may result in slow convergence of the solution.

Commonly used optimization techniques that do not include gradient calculation of a function might not be ideal for optimization of complex problems. Complex problems may include a large number of parameters, and the efficacy of the above-described techniques may deteriorate in such situations. Incorporation of these optimization techniques in machine learning models, such as the Boltzmann machine and VAE, might not be ideal due to their time and resource intensiveness for models handling large data sets. Poor convergence when training the model may result in poor performance of the trained machine learning model during use.

As such, there exists a need for an optimization technique to quickly and accurately estimate a gradient of a function associated with a complex problem. Such a technique should be able to treat the desired function like a “black box” and be usable within machine learning models without a reduction of model efficacy.

To provide such a model, the SPSA technique described above can be combined with an algorithm referred to as the “ADAM optimizer”. The ADAM optimizer is a first-order stochastic gradient-based optimization technique based on adaptive estimates of lower-order moments. In the ADAM optimizer, a first order moment and a second order moment are used to accelerate optimization in a direction of an extremum and mitigates effects of noisy steps in undesired directions. As well, the ADAM optimizer has an adaptive learning rate based on the moving average of the magnitudes of the recent gradients. Further details regarding the algorithm of the ADAM optimizer can be found in Kingma et al. (Kingma, Diederik P., and Jimmy Ba. “Adam: A method for stochastic optimization.” arXiv preprint arXiv:1512.6980 (2014)).

The ADAM optimizer has been successfully used in machine learning models with large datasets and/or high-dimensional parameter spaces. It is computationally efficient, robust, and requires little memory. This technique has been proven appropriate for non-stationary objectives and problems with very noisy and/or sparse gradients. However, the ADAM optimizer is subject to the disadvantages associated with gradient descent-based methods. As well, the exponential moving average of ADAM and, in some cases, a learning rate that is circumstantially too small, may result in failure of the objective function to converge or convergence to a sub-optimal solution.

For accurate and robust optimization of a value of an objective function parameter, gradients of an objective function can be estimated by simultaneous perturbation before applying the first and second moment heuristics of the ADAM optimizer to update values of optimizable parameters. First and second moment estimates may be calculated using a gradient estimation technique requiring only two function evaluations, instead of the calculated gradient normally relied upon by the ADAM optimizer that might be resource intensive and/or inaccurate in some applications. Further, an optimizer including first and second moments determined at each iteration by estimating gradients using simultaneous perturbation can be augmented with use of a quantum processor. By generating an array of random variables based on samples obtained from a quantum processor, the random directions are truly random values sampled from a suitable distribution, and the removal of bias may lead to quicker and more accurate optimization relative to gradient estimation using pseudo-random samples obtained in software.

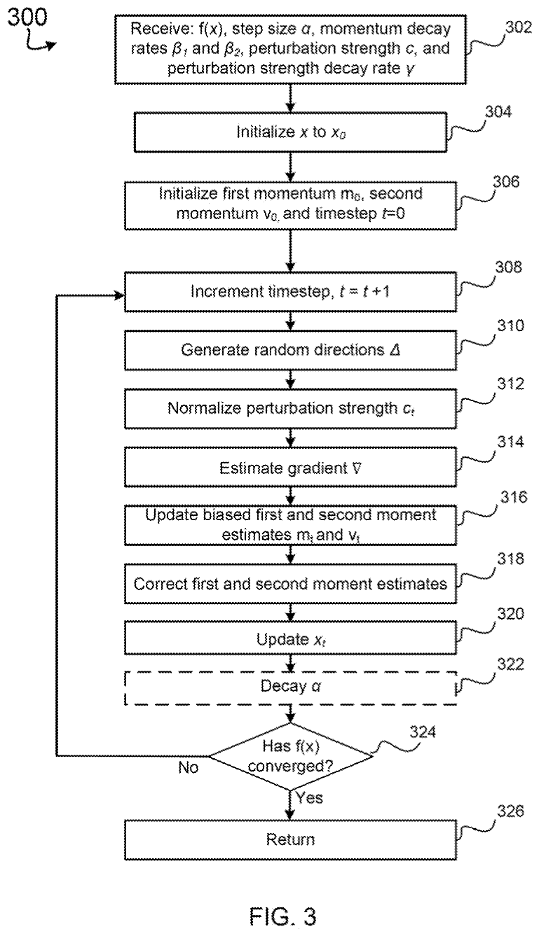

FIG. 3 is a flow diagram illustrating an example method 300 for optimizing an objective function in accordance with the presently described systems, devices, articles, and methods. Method 300 can be performed by a processor, such as digital processor(s) 106 of digital computer 102 in FIG. 1. In some implementations, method 300 can optionally be performed by a digital processor in communication with a quantum processor, such as by analog computer 104 of FIG. 1 or the superconducting quantum processor described by circuit 200 of FIG. 2. The instructions, that when executed, instruct the digital processor to perform acts 302 to 326, can be stored in a memory associated with the digital processor. For instance, the instructions for method 300 may be stored in memory 122 of digital computer 102.

Method 300 can begin based on an instruction provided to digital processor(s) 106, for example, by a user via a component of user input/output subsystem 108. Alternatively, an initiation instruction may be provided to digital processor(s) 106 based on a function call or invocation within a program architecture or a machine learning model.

At 302, the digital processor initiates method 300, at which the function to be optimized, f(x), and a plurality of parameters and their values are received. Function f(x) may be an objective function that defines the problem to be solved, a loss function to be minimized in training of a machine learning model, or any other suitable function to be optimized. Parameters received at 302 include: c, which is an initial perturbation strength, and γ, which is a rate of perturbation strength decay, as used in SPSA calculations. Parameters received at 302 include: a, which is a step size, as well as β₁ and β₂, which are respective first and second momentum decay rates, as used in ADAM calculations. In some implementations, a value & may also be received, which may have a small strictly positive value and provides increased stability to the optimizer.

In some implementations, a value of a may be 0.001. In some implementations, values of β₁ and δ₂ may be 0.9 and 0.999, respectively. In some implementations, a value of & may be 10⁻⁸.

At 304, the digital processor initializes x to an initial value x₀. A suitable value of x₀ may be determined based on the nature of function f(x), for instance, by random selection or input from a user. In implementations in which a value of more than one parameter is to be optimized during method 300, the digital processor may initialize each parameter being optimized at 304.

At 306, the digital processor initializes first moment m₀, second moment v₀, and a timestep t. The timestep is initialized such that t=0. First moment m₀ and second moment v₀ can be initialized as vectors with their elements having a value of zero.

At a first occurrence of act 308, initialization of the parameter values of the optimizer has been completed, and the digital processor increments a counter for timestep t such that t=t+1.

At 310, the digital processor generates random directions Δ, which takes the form of a simultaneous perturbation vector. Generation of Δ may be performed according to SPSA techniques. The generation of Δ may be expressed as: 4=(b·2)−1, in which b is an array of random binary values for each parameter.

In some implementations, array b can be generated using the Monte Carlo method, and each of the elements of array b are independently generated from a symmetric, zero mean probability distribution that satisfies an inverse moment bound. A zero mean probability distribution is a discrete probability distribution centered around zero. In some implementations, the probability distribution can optionally be a Bernoulli ±1 distribution. However, this is merely an example and is not intended to be limiting; alternatively, elements of b can be obtained from any other suitable distribution. As well, the elements of b need not be generated using the Monte Carlo method and can be generated using any suitable approach or technique such that elements of b are being independently generated from a symmetric, zero mean probability distribution that satisfies an inverse moment bound. In some implementations, the elements of b may be obtained using an analog processor, such as by operating a quantum processor as a sample generator.

At 312, the digital processor normalizes the perturbation strength cₜ for the current timestep. This normalization is performed based on the SPSA algorithm as follows: cₜ=c/t^{γ}. The normalized perturbation strength cₜ is the quotient of the initial perturbation strength c, received at 302, and the current value of the timestep counter t experiencing exponential decay at a rate of γ, also received at 302.

At 314, a gradient ∇ of function f(x) at the current timestep is estimated based on the technique used in the SPSA algorithm. Here, the gradient is not calculated based on partial derivatives of f(x), but instead by the equation:

$${∇}_{t} = ( f ( {x}_{t} + {c}_{t} * Δ ) - f ( {x}_{t} - {c}_{t} * Δ ) ) / ( 2 * {c}_{t} * Δ ) .$$

The two terms in the numerator of the equation, f(xₜ+c+ₜ*Δ) and f(xₜ−c+ₜΔ), are the two evaluations of the desired function f(x) at the current timestep t, which have been simultaneously perturbed based on the term ±cₜ+*Δ, which herein may also be referred to as the perturbation parameter. The gradient ∇ₜ is estimated using an algebraic approach to measuring the rate of change between the two function measurements.

At 316, the first moment mₜ and second moment vₜ are updated through estimation of the biased moments at the current time step. Although these estimations are determined in accordance with the algorithm of the ADAM optimizer, the gradient used in the estimations of mₜ and vₜ is ∇ₜ estimated at 316. The updating of the biased first moment estimate and biased second moment estimate is based on β₁ and β₂, respectively.

Determination of the biased first moment estimate can be implemented via the following equation: mₜ=β₁(mₜ₋₁)+(1−β₁)(∇ₜ).

Likewise, determination of the biased first moment estimate can be implemented via the following equation: vₜ=β₂(vₜ₋₁)+(1−β₂)(∇ₜ²).

At 318, the digital processor corrects the biased estimates of the first moment mₜ and second moment vₜ in accordance with the algorithm of the ADAM optimizer. Correction of the biased first moment mₜ is provided by: \hat{m}ₜ=mₜ/(1−β₁^{t}) and correction of the biased second moment vis achieved by: vₜ=vₜ/(1−β₂^{t}).

At 320, a value of the parameter xₜ of f(x) is updated based on the corrected first moment estimate \hat{m}ₜ and the corrected second moment estimate \hat{v}ₜ determined at 318, as well as values of parameters α and ε received by the digital processor at 302. This update is performed in accordance with the algorithm of the ADAM optimizer as: xₜ=(xₜ₋₁−α)*\hat{m}ₜ)/(\sqrt{vₜ}+ε). In implementations where values of more than one parameter are to be optimized, a value of each of the parameters to be optimized is updated at 322 using the described procedure.

At 322, the digital processor can optionally perform a calculation to decay the step size a, such that this parameter has a reduced impact in updating the value of parameter x of f(x) at future iterations of the algorithm. Calculation of the decay of a may be implemented by suitable approaches or techniques, such as such as a predetermined step size or multiplier of the current value of α, or by another approach or technique.

At 324, the digital processor evaluates whether the function of interest f(x) has converged, in part by evaluation f(x) using the updated value of x. Convergence of f(x) indicates that a value of parameter x at the current timestep t provides a maximum or minimum value of f(x). Once f(x) has converged, f(x) has been optimized, even if f(x) is not at the absolute optimal.

If the evaluation at 324 determines that f(x) has not converged, method 300 returns to 308 where the counter for timestep t is incremented. Acts 308 to 324 are repeated until the digital processor has determined that f(x) has converged, at which point method 300 proceeds to 326.

At 326, the digital processor returns the results of method 300. In some implementations, this includes returning a value of parameter x at the timestep when f(x) converges, or values of a plurality of parameters that were optimized. Additionally, or alternatively, an evaluation of f(x) when f(x) converges may be returned. In some implementations, the returned value(s) may be provided directly to a user who initiated method 300. The returned value(s) may be provided to a system architecture or machine learning model that initiated method 300. In some implementations, the returned value(s) may be stored in a memory associated with the digital processor, such as memory 122 of digital computer 102.

Quantum-Classical Optimization without Solving for Gradients

Quantum-classical optimization can provide improved solutions to optimization problems, and may be applied to quantum-classical machine learning. A hybrid computing system including a classical processor in communication with a quantum processor, such as computing system 100 of FIG. 1, may be used to execute a quantum-classical optimizer or a quantum-classical machine learning model. Some portions of the optimizer or model may be implemented using classical computing methods, such as by digital processor(s) 106 of digital computer 102, and other portions of the optimizer or model may be implemented using quantum computing methods, such as by quantum processor 126 of analog computer 104.

A quantum processor designed to perform quantum annealing, simulated annealing and/or adiabatic quantum computation may be operated as a sample generator. Here, each sample corresponds to a state of the quantum processor (i.e., a set of states of all qubits within the quantum processor) and the population corresponds to all possible states of the quantum processor (i.e., all possible combinations of states of all qubits within the quantum processor). Use of a quantum processor as a sample generator is described in further detail In U.S. Pat. No. 11,410,067.

A quantum processor can be used as a random number generator, which provides samples having a randomness exceeding the randomness of samples produced by random number generators implemented in software. Random number generators implemented by software generate pseudo-random numbers that may be generated by an easily reproducible and/or predictable methods, which might not be ideal for applications that benefit from true randomness.

Conversely, a sampling device including a quantum processor exploits the inherent randomness in a physical quantum system, and the associated act of measurement, as a source of randomness. In some implementations, the sampling rate may exceed a maximum sampling rate of a digital computer from complex distributions. In some implementations, thermal effects contribute to randomness of the samples obtained in addition to quantum effects of the system.

In some implementations, generation of truly random samples from a particular distribution using a quantum processor can include input of the particular distribution to a digital processor communicatively coupled to the analog processor, which the digital processor can use to define a Hamiltonian having a highly entangled nontrivial ground state. The digital processor can introduce one or more distortions to the Hamiltonian by one or more random variations based on the specified distribution to modify the Hamiltonian. The digital processor can then embed the modified Hamiltonian onto hardware of the quantum processor, and cause the quantum processor to evolve based on the modified Hamiltonian to generate a set of random numbers having the input distribution. For more detail on random number generation using a quantum processor, see U.S. patent application Ser. No. 18/113,735.

Random samples generated by the quantum processor may be used to provide one or more parameter values of an optimizer or a machine learning model, such as a vector or array comprising random values following a specific distribution. Samples generated by the quantum processor may be more desirable than a random distribution generated by a classical processor due to the quicker sampling rate and increased randomness of the samples due to the inherent pseudo-random nature of classical sampling.

A quantum processor designed to perform quantum annealing, and/or adiabatic quantum computation may be advantageously capable of providing optimal or near optimal samples efficiently, thereby providing a significant increase in optimizer or model efficiency over a purely classical optimizer or model.

Referring back to the discussion of FIG. 3 above, method 300 for optimization of values of parameters without calculating gradients can optionally be performed by a digital processor in communication with a quantum processor, such as quantum processor 126 of FIG. 1 or circuit 200 of the example quantum processor of FIG. 2. To do so, acts 302 to 308 and acts 312 to 326 may be performed by the digital processor and, in some implementations, act 310 can be performed, at least in part, by the quantum processor. The quantum processor can be used to generate b, which is the array of random binary values for each parameter that is used to calculate Δ. The elements of array b may be obtained by sampling the quantum processor when the quantum processor is programmed to provide a suitable distribution that satisfies the conditions of the SPSA algorithm.

The samples measured by the quantum processor may be returned to the digital processor, and likewise the digital processor may receive samples measured by the quantum processor. This may be initiated, for example, by instructions sent from digital processor(s) 106 of digital computer 102 to readout control system 128 of analog computer 104, which may instruct for the sample data to be transmitted to digital computer 102. Once returned, the digital processor may calculate Δ using the samples generated by the quantum processor as b.

A method that uses a quantum processor to obtain the samples that comprise array b may provide an improvement in efficiency over implementations of method 300 performed entirely using a digital processor. Use of random search directions generated by a digital processor for simultaneous perturbation of the optimizable parameter enables the estimated gradient to nearly track the actual gradient path of the objective function due to its almost unbiased nature. Through generation of the random directions using a quantum processor, truly unbiased samples can be obtained, and the estimated gradient may track more closely to the actual gradient path. As such, the increased randomness of samples obtained via the quantum processor relative to the pseudo-random samples obtained by a digital processor may more quickly determine optimal parameter values of a given objective function.

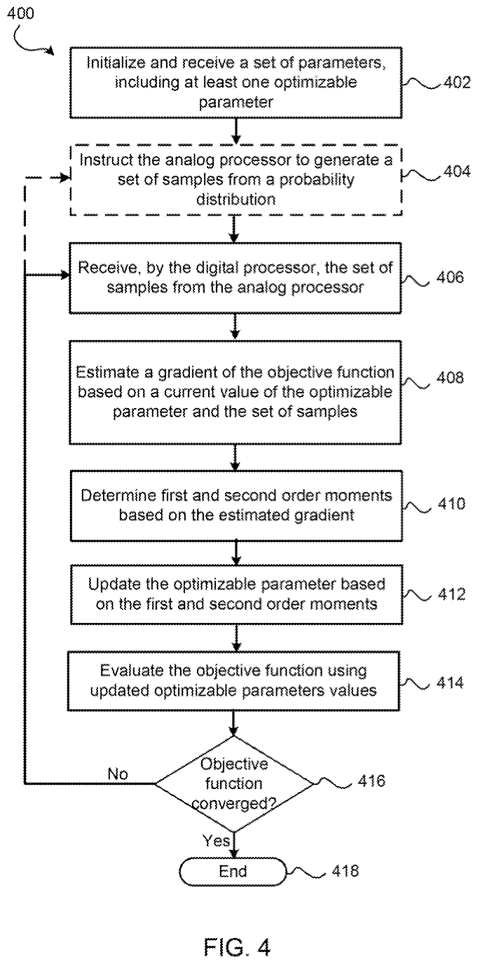

FIG. 4 is an example hybrid computing method 400 to optimize values of parameters of an objective function. Method 400 can be performed by a hybrid computer that includes at least one digital processor, such as digital processor(s) 106 of digital computer 102, in communication with at least one quantum processor, such as by quantum processor 126 or circuit 200.

Method 400 can be performed when the at least one digital processor executes instructions that cause the at least one digital processor to perform acts 402 to 418. Those of skill in the art will appreciate that alternative embodiments may omit certain acts and/or include additional acts.

The instructions can be stored in a memory associated with the at least one digital processor. For instance, the instructions for method 400 may be stored in memory 122 of digital computer 102.

At 402, the at least one digital processor receives and/or initializes a set of parameters. The set of parameters includes at least one optimizable parameter. In some implementations, act 402 can include at least acts 302, 304, and 306 of method 300. The at least one digital processor can receive: an objective function, a step size a, momentum decay rates 31 and 62, an initial perturbation strength c, a perturbation strength decay rate γ, and ¿. The at least one digital processor can initialize at least: an initial value of one or more optimizable parameters received by the at least one digital processor, an initial value of a first momentum m₀, and an initial value of a second momentum v₀.

At 404, the at least one digital processor optionally instructs the quantum processor to generate a set of samples from a probability distribution. The at least one digital processor can transmit a signal to program parameter values of the quantum processor, and embed a problem to be solved by quantum computation that corresponds to random sample selection from the probability distribution. The probability distribution can be one of: a symmetric, zero mean probability distribution that satisfies an inverse moment bound, a Boltzmann distribution, or another distribution that satisfies the criteria of SPSA. In some implementations, the quantum processor can comprise a plurality of qubits. The quantum processor can perform quantum annealing and/or adiabatic quantum computation, and instruction of the quantum processor to generate the set of samples may include programming the quantum processor to have the probability distribution over the plurality of qubits, and instruction of the quantum processor to perform quantum evolution using the plurality of qubits.

At 406, the at least one digital processor receives, or otherwise retrieves, the set of samples from the quantum processor.

In implementations where each sample of the set of samples is generated by an instance of the quantum processor performing quantum evolution, act 406 can include receiving a set of states of the plurality of qubits observable after quantum evolution that correspond to the probability distribution.

In some implementations, samples of the set of samples can be received by the at least one digital processor from the quantum processor using techniques described in US Patent Application Publication No. 2021/0248506 or U.S. Provisional Patent Application No. 63/265,605.

At 408, the at least one digital processor estimates a gradient of the objective function based on a current value of the optimizable parameter and the set of samples from the probability distribution. In implementations having more than one optimizable parameter, the gradient is estimated based on current values of all of the optimizable parameters and the set of samples. In some implementations, act 408 can include act 314, and optionally acts 310 and 312, of method 300.

In some implementations, estimation of the gradient of the objective function includes: use of the samples obtained from the analog processor as the random binary values of array b, generation of an array of random directions Δ based on array b, and subsequently estimation of the gradient based on the current value of the at least one optimizable parameter and the array of random directions Δ.

In some implementations, estimation of the gradient of the objective function includes obtaining a first and a second objective function value. The first objective function value is obtained through evaluation of the objective function with the current value of the at least one optimizable parameter perturbed by a perturbation parameter cₜ*Δ in a first direction. For instance, the first objective function value can be f(xₜ+cₜ+Δ). The second objective function value is obtained through evaluation of the objective function with the current value of the at least one optimizable parameter perturbed by a value of a perturbation parameter in second direction that opposes the first direction. For instance, the second objective function value can be f(xₜ−cₜ+Δ). The gradient can be estimated through determination of a rate of change between the first and the second objective function values.

At 410, the at least one digital processor determines first and second moments based on the estimated gradient. In some implementations, act 410 can include acts 316 and 318 of method 300. The at least one digital processor can update biased moments using the gradient estimated with random binary values that were obtained as samples from the quantum processor.

At 412, the at least one digital processor updates the value of the optimizable parameter based on the first and second order moments. In implementations having more than one optimizable parameter, a value of each of the optimizable parameters is updated. In some implementations, act 412 can include act 320 of method 300.

At 414, the at least one digital processor evaluates the objective function using the updated values of the one or more optimizable parameters to determine an objective function value of the current iteration.

At 416, the at least one digital processor assesses whether the objective function has converged. The value of the objective function at the current iteration determined at 414 may be compared to values of the objective function at previous iterations, and it can be determined that the objective function has converged if the current value is trending in the direction of, and stabilizing near, a singular optimal value. In some implementations, convergence can be assessed based on a convergence criterion, such as a change in objective function value over a fixed number of iterations being less than a defined threshold, or another criterion known in the art.

If it is determined that the objective function has not yet converged, method 400 returns to act 404 in implementations that include the act of instructing the quantum processor to generate a set of samples from a probability distribution, and acts 404 to 414 are reiterated until the objective function converges. In implementations in which act 404 is omitted, control returns to act 406 if it is determined that the objective function has not yet converged, and acts 406 to 414 are reiterated until the objective function converges.

If it is determined that the objective function has converged, method 400 terminates at 418 until, for example, method 400 is called again.

In some implementations, there may be a non-transitory computer-readable medium storing instructions that, when executed by at least one digital processor, causes the at least one digital processor to perform method 400.

Method 300 and/or method 400 can be performed by a hybrid computing system including a digital computer with at least one digital processor and an analog computer with at least one quantum processor. The hybrid computing system can include instructions stored in memory of the digital computer to execute method 300 and/or method 400, and communicative coupling between the digital and analog computers can enable the at least one digital processor to instruct operation of the at least one quantum processor.

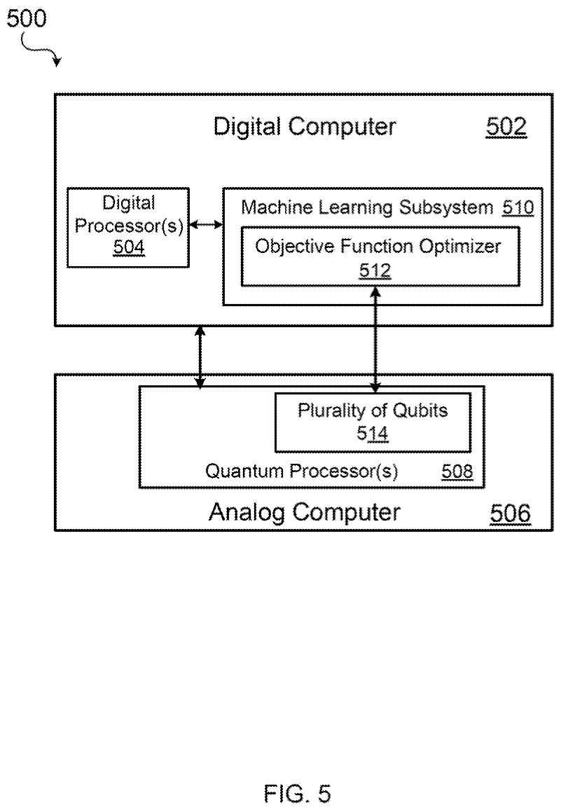

FIG. 5 is a schematic diagram of an example system 500 to optimize an objective function, in accordance with the presently described systems, devices, articles, and methods. System 500 includes a digital computer 502 having at least one digital processor 504, which is communicatively coupled to an analog computer 506 having at least one quantum processor 508.

In some implementations, system 500 may be part of a hybrid computing system such as computing system 100 in FIG. 1. In such an implementation, digital computer 502 and digital processor 504 may be digital computer 102 and digital processor(s) 106, respectively. In some implementations, digital computer 502 may be a physical computing system having components arranged in a single location, or digital computer 502 may be a cloud computing system having components arranged in geographically remote locations. As well, analog computer 506 and quantum processor 508 may be analog computer 104 and quantum processor 126, respectively.

Digital computer 502 includes digital processor 504 and a machine learning subsystem 510, which are arranged in communication with one another. Machine learning subsystem 510 can be used in performance of machine learning. In some implementations, at least a portion of machine learning subsystem 510 may be machine-readable instructions, that, when executed by digital processor 504, perform acts for implementing machine learning methods described herein, such as a Quantum Boltzmann Machine, or a model therewithin. These machine-readable instructions may be stored, for example, in a memory associated with digital computer 502, such as system memory 122 of digital computer 102. Additionally, or alternatively, at least a portion of machine learning subsystem 510 may include at least a portion of a digital processor that is dedicated to executing instructions for performing one or more machine learning methods.

Although digital processor 504 is shown as part of digital computer 502 in FIG. 5, digital processor 504 can alternatively be arranged external to, but in communication with, digital computer 502 (for example, as part of a different digital computer). In some implementations, more than one digital processor may be included as part of system 500, and at least one digital processor 504 may be arranged within digital computer 502 and one or more of these digital processors may be arranged external to digital computer 502 (for example, as part of one or more different digital computers). In such an implementation, each digital processor arranged external to digital computer 502 may be communicatively coupled to digital computer 502, which may be communicatively coupled to at least one digital processor 504 within digital computer 502 and/or machine learning subsystem 510.

Although machine learning subsystem 510 is shown as part of digital computer 502 in FIG. 5, machine learning subsystem 510 can optionally be arranged in a distributed manner, such that all or a portion of machine learning subsystem 510 is located external to a physical computing system of digital computer 502. For example, a portion of machine learning subsystem 510 may be instructions stored on a cloud and accessed via digital processor 504 of digital computer 502. In another implementation, digital computer 502 may include more than one physical computing systems, and may include components in different physical locations that are in communication with one another.

Machine learning subsystem 510 includes at least a portion of an objective function optimizer 512. In some implementations, at least a portion of objective function optimizer 512 may be machine-readable instructions, that, when executed by digital processor 504, perform acts to train and/or deploy a machine learning model that includes optimization of an objective function and/or quantum-classical optimization of an objective function, such as programming and instructing execution of quantum processor 508. In some implementations, objective function optimizer 512 may include a portion of the memory associated with digital computer 502, such as system memory 122, so that machine-readable instructions comprising part of the method to optimize the objective function may be stored as part of objective function optimizer 512. Additionally, or alternatively, at least a portion of objective function optimizer 512 may include at least a portion of a digital processor that is dedicated to execution of instructions to perform a method to optimize an objective function, such as method 300 or method 400, which can optionally include transmission of instructions for execution of quantum processor(s) 508.

Quantum processor 508 includes a plurality of qubits 514. In some implementations, plurality of qubits 514 can, for example, take the form of qubits 201, 202 of the quantum processor provided at least in part by circuit 200 of FIG. 2. Plurality of qubits 514 can be superconducting qubits, such as superconducting flux qubits or superconducting charge qubits. Qubits of plurality of qubits 514 can be magnetically, galvanically, or capacitively coupled to one another by superconducting couplers, such as coupler 210 of circuit 200.

Analog computer 506 is arranged in communication with digital computer 502. In some implementations, digital processor 504 of digital computer 502 can provide instructions to quantum processor 508 that control the behavior of one or more components of analog computer 506, such as plurality of qubits 514 and/or couplers in quantum processor 508. In some implementations, digital computer 502 may control one or more components of quantum processor 508 via additional control system circuitry in analog computer 506, such as by qubit control system 130, coupler control system 132, and/or readout control system 128 of computing system 100. In some implementations, digital processor 504 of digital computer 502 can instruct quantum processor 508 to perform computations, such as those described herein to obtain samples by way of objective function optimizer 512.

Quantum processor 508 can be an analog processor that performs quantum annealing and/or adiabatic quantum computing. In some implementations, digital processor 504 of digital computer 502 can transmit signals that instruct quantum processor 508 to perform quantum annealing based on a prescribed annealing schedule. In some implementations, objective function optimizer 512 can include non-transitory computer-readable instructions, that, when executed by digital processor 504, instruct quantum processor 508 to perform quantum annealing as described herein.

Analog computer 506 can include readout circuitry and/or structures for measuring the states of qubits of plurality of qubits 514. For example, following quantum annealing, a state of each qubit in plurality of qubits 514 may be obtained from quantum processor 508 and transmitted to digital computer 502. In some implementations, measured states of the qubits in plurality of qubits 514 can be provided directly to objective function optimizer 512 for use in a machine learning model as described herein. In some implementations, the measured states of the qubits in plurality of qubits 514 can be stored in a memory, including: a memory of digital computer 502, such as system memory 122 of digital computer 102, and more specifically a memory arranged as part of machine learning subsystem 510 and/or objective function optimizer 512; or, a memory located externally to system 500, which is communicatively coupled with analog computer 506 and digital computer 502.

Applications of Quantum-Classical Machine Learning without Solving for Gradients

Augmenting machine learning models with a quantum processor can improve model performance by increasing computation speed and/or accuracy of a determined solution. Some machine learning models include a training phase, in which one or more parameters of the machine learning model are optimized. In some applications, use of a quantum processor may be used to train a machine learning model, for instance, as a sample generator to obtain samples and/or candidate solutions that exploit behavior of qubits in a quantum processor. In some implementations, system 500 can be used to train a machine learning model and/or method 400 can be used as some or all of a method to optimize one or more parameters during training of a machine learning model.

One example of a quantum-classical machine learning model is a Quantum Boltzmann Machine (QBM). The Boltzmann machine of the QBM is described by a transverse Ising Hamiltonian. The Hamiltonian parameters of the model can be local qubit biases and coupler values. The transverse Ising Hamiltonian is as follows:

$$H = - {\sum }_{a} {Δ}_{a} {σ}_{a}^{x} - {\sum }_{a} {h}_{a} {σ}_{a}^{z} - {\sum }_{a , b} {J}_{ab} {σ}_{a}^{z} {σ}_{b}^{z}$$

where σₐ^{x} and σₐ^{z} are Pauli matrices, and Δₐ is the qubit tunneling amplitude. In each measurement using the quantum processor, the states of the qubits are read out in the σ^{z} basis, and the outcome comprises classical binary variables for both the hidden and the visible variables. Each configuration of visible and hidden variables can have a probability given by a Boltzmann distribution that depends on eigenvalues of the transverse Ising Hamiltonian.

For a detailed description of the QBM, see U.S. Pat. No. 11,062,227 and Amin et al. (Amin, Mohammad H., et al. “Quantum Boltzmann machine” Physical Review X 8.2 (2018): 021050).

In at least some implementations, a measured quality of learning of a QBM may exceed that of a classical quantum Boltzmann machine, such that the samples obtained are closer to the data distribution. As well, since in particular conditions a quantum processor can natively generate samples having a probability given by a Boltzmann distribution, the amount of post-processing performed on these samples may be reduced or eliminated.

Another example of a quantum-classical machine learning model is a Quantum Variational Auto-Encoder (QVAE). A QVAE is a variational auto-encoder having a latent generative method that is implemented as a QBM. For a detailed description of the QVAE, see U.S. Patent Application Publication No. 2020/0401916 and Khoshaman et al. (Khoshaman, Amir, et al. “Quantum variational autoencoder” Quantum Science and Technology 4.1 (2018): 015001).

Minimizing the negative log-likelihood of a Boltzmann machine of a QBM is generalized by:

$$ℒ = - {\sum }_{v} {P}_{v}^{data} log ( {P}_{v}^{meas} )$$

Here, Pᵥ^{meas} refers to a probability of a measured sample having a state v of the visible variables and Pᵥ^{data} refers to a probability of state vector v being in the training dataset. This computation is intended to determine values of Hamiltonian parameters θε{hₐ,Jₐ) that optimize the loss function. The probability that the QBM returns a state v after a measurement is Pᵥ^{meas}=Tr[ρΛᵥ] where Λᵥ=|v [symbol] v|⊗ℑₕ, and ℑₕ is an identity matrix acting on the hidden variables. As such, the transverse Ising Hamiltonian loss function can be expressed as:

$$ℒ = - {\sum }_{v} {P}_{v}^{data} log \frac{Tr [ {Λ}_{v} {e}^{h} ]}{Tr [ {e}^{h} ]}$$

Subsequently, the gradient of the log-likelihood of the transverse Ising Hamiltonian can be expressed as:

$$\frac{\partial ℒ}{\partial θ} = {\sum }_{v} {P}_{v}^{data} ( \frac{Tr [ \frac{\partial }{\partial θ} {e}^{- β H} {Λ}_{v} ]}{Tr [ {e}^{- β H} {Λ}_{v} ]} - \frac{Tr [ \frac{\partial }{\partial θ} {e}^{- β H} ]}{Tr [ {e}^{- β H} ]} )$$

and the first term of this gradient cannot be estimated via sampling. To mitigate this limitation, an upper bound of the log-likelihood may be implemented and then minimized. This enables the quantum processor to obtain samples that can estimate the gradient needed to optimize values of the parameters of the transverse Ising Hamiltonian.

Determination of the gradient of the transverse Ising Hamiltonian of the QBM is non-trivial, and performance, by a quantum processor, of quantum annealing with a linear annealing schedule does not inherently return a Boltzmann distribution. To reduce or mitigate the challenges associated with sampling when equilibrium dynamics are present, it may be advantageous to substitute the gradient estimation technique with an optimization technique that does not require gradient calculation. Such a substitution may also be beneficial when gradient estimation may be difficult due to hardware noise affecting a quality of the measurements performed by the quantum processor.

The optimization technique of method 400 can be implemented to train a QBM, instead of estimation of the gradient of the bounded log-likelihood function according to the technique known in the art. When using method 400 to train the QBM, Pᵥ^{data} of the generalized Boltzmann machine loss function can comprise samples obtained via quantum computation at acts 404 and 406. For instance, Pᵥ^{data} may include states of qubits 201, 202 read out by readout control system 128 from quantum processor 126 or the example quantum processor of circuit 200. The qubit states may be stored in memory as one of modules 124 and/or provided directly to the digital processor that executes instructions to perform method 400. In implementations in which optimization is performed using system 500, digital processor 504 and/or objective function optimizer 512 may cause quantum processor 508 to return data having a known distribution for a predetermined number of iterations to obtain a predetermined number of samples. Each sample may be a set of states of plurality of qubits 514 of analog computer 506 (e.g., quantum processor 508) after an instance of execution.

At 402, the desired function f(x) provided to the optimizer of method 400 can be the loss function of a Boltzmann machine. In some implementations, f(x) may be the log-likelihood of the transverse Ising Hamiltonian loss function. In other implementations, f(x) may be the bounded log-likelihood of the transverse Ising Hamiltonian loss function. Method 400 can be used to optimize one or more values of parameters of the transverse Ising Hamiltonian. This may include parameters θ∈{hₐ, Jₐ), and may also include additional parameters that are not readily tunable using optimization techniques known in the art.

Performance of the gradient estimation of the optimizer of method 400 is advantageously more efficient than the gradient estimation technique known in the art to train the QBM. Here, the gradient V estimated at act 408 involves only evaluations of the loss function of the QBM that have been simultaneously perturbed based on the term: ±cₜ*Δ. Estimation at act 408 may be significantly more efficient than estimation that requires sampling the quantum processor at a time when its qubits exhibit equilibrium dynamics.

The above-described use of method 400 may improve an optimization solution. It may also allow for efficient training of the QBM using training data that includes imperfect, noisy samples or samples obtained when qubits exhibit non-equilibrium dynamics that may be more easily obtained.

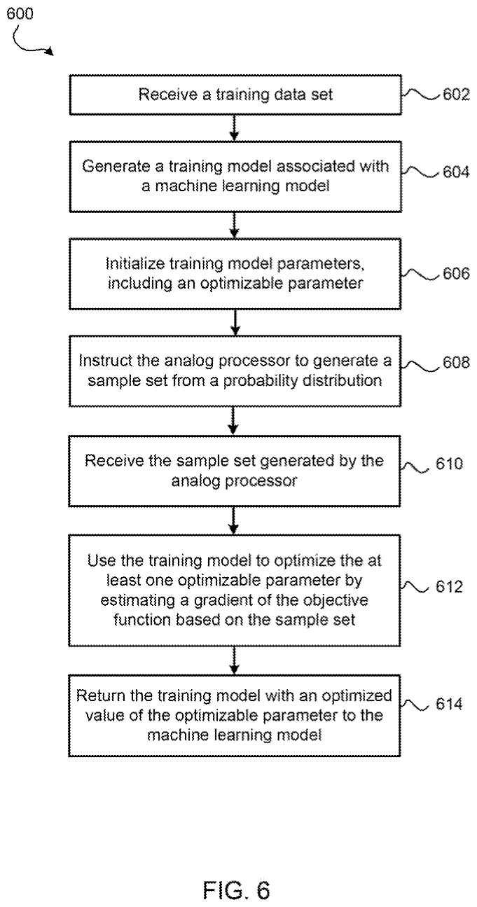

FIG. 6 is an example method 600 to train a quantum-classical machine learning model. Method 600 can be performed by a hybrid computer that includes at least one digital processor, such as digital processor(s) 106 of digital computer 102 or digital processor 504 of digital computer 502, in communication with at least one quantum processor, such as by quantum processor 126, circuit 200, or quantum processor 508.

Method 600 can be performed when the at least one digital processor executes instructions that cause the at least one digital processor to perform acts 602 to 614. Those of skill in the art will appreciate that alternative embodiments may omit certain acts and/or include additional acts.

The instructions can be stored in a memory associated with the at least one digital processor. For instance, the instructions for method 600 may be stored in memory 122 of digital computer 102 and/or in memory associated with objective function optimizer 512 (e.g., of machine learning subsystem 510) of digital computer 502.

Method 600 is described below as training a QBM; however, this is merely an example and is not intended to be limiting. The training of a QBM can be used as the training of a training model for a plurality of different machine learning models, such as a QVAE or a generative model as discussed in further detail below as part of a larger machine learning model, network, or architecture. Method 600 can also apply to a different, suitable training model.

In some implementations, method 600 can begin based on an instruction provided to the at least one digital processor; for example, a user may provide instructions to digital processor(s) 106 via a component of user input/output subsystem 108. Alternatively, an initiation instruction may be provided to the at least one digital processor based on a function call or invocation within a larger program, such as a program executing a larger machine learning model, network, or architecture. In implementations in which method 600 is performed using system 500, digital processor 504 may initiate method 600 based on instructions provided by machine learning subsystem 510.

At 602, the at least one digital processor receives a training data set. The training set includes data for which at least the input values are known for the machine learning model. The output values corresponding to the input values of data in the training set may also be known for machine learning models using supervised learning. In some implementations, data relating to the training set is received by machine learning subsystem 510 or a memory associated with machine learning subsystem 510.

At 604, the at least one digital processor generates a training model associated with a machine learning model. The training model has an associated objective function. In some implementations, the training model may be a QBM. At least one digital processor, such as digital processor(s) 106 may generate a transverse Ising model that describes the QBM. In some implementations, digital processor 504 may execute instructions of machine learning subsystem 510 to generate the at least one machine learning model.

At 606, the at least one digital processor initializes training model parameters. The training model parameters include at least one optimizable parameter of the machine learning model.

In some implementations, digital processor(s) 106 may initialize parameters of the transverse Ising model of the QBM, such as θ∈{hₐ,Jₐ), and parameters of an optimizer used to estimate gradients of the transverse Ising model of the QBM, such as c, γ, α, β₁, and β₂. The optimizer may be the optimizer of method 300, and the initialized parameters may include: c, γ, α, β₁, β₂, and ε described previously. The at least one optimizable parameter may be at least one Hamiltonian parameter of the transverse Ising model of the QBM. In some implementations, digital processor 504 may initialize values of the parameters of a QBM of machine learning subsystem 510 and of objective function optimizer 512.

At 608, the at least one digital processor instructs the analog processor to generate a sample set from a probability distribution. The at least one digital processor can: transmit signals to program values of parameters of the analog processor, embed a problem onto the analog processor, and instruct execution of the analog processor. The signals can instruct the analog processor to generate samples having a predetermined probability distribution, such as a symmetric, zero mean probability distribution having an inverse moment bound.

In implementations performed by system 500, digital processor 504 instructs quantum processor 508 to perform quantum annealing and/or adiabatic quantum computation, which evolves states of plurality of qubits 514. Digital processor 504 can instruct quantum processor 508 to execute a predetermined number of times to obtain a predetermined number of samples. Each sample is a set of states of plurality of qubits 514 after a respective instance of performing quantum evolution, which may be part of quantum annealing and/or adiabatic quantum computation.

At 610, the at least one digital processor receives the sample set that has been generated by the analog processor.

Act 610 can include, for each sample, receipt of a set of states of the plurality of qubits observable after an instance of quantum evolution. After each execution of quantum processor 508, objective function optimizer 512 can receive a sample, which is a set of states of plurality of qubits 514. Each sample can be a sample from a probability distribution suitable for generation of an array of random directions for use in perturbation of the at least one optimizable parameter. A fixed number of samples are received by digital processor 504 and/or objective function optimizer 512.

In some implementations, sample sets can be received by the at least one digital processor from the quantum processor according to the techniques described in US Patent Application Publication No. 2021/0248506 and International Patent Application Publication No. WO 2023/114811.

At 612, the at least one digital processor uses the training model to optimize the value of the at least one optimizable parameter of the machine learning model. Use of the training model to optimize the value of the at least one optimizable parameter includes estimation of a gradient of the training model objective function using: a current value of the at least one optimizable parameter, and a perturbation parameter based on the sample set generated by the analog processor.

In some implementations, act 612 can include at least acts 408-416 of method 400 of FIG. 4 and/or some or all of method 300 of FIG. 3.

In some implementations, use of the training model to optimize the value of the at least one optimizable parameter of the machine learning model can include minimization of a loss function based on data belonging to the training set and the sample set. In some implementations, digital processor(s) 106 may be used to train the QBM to optimize at least one Hamiltonian parameter value. In implementations performed by system 500, digital processor 504 can be used to train a QBM of machine learning subsystem 510 through optimization of at least one Hamiltonian parameter value using objective function optimizer 512. The loss function may be the log-likelihood describing a difference between data belonging to the training set and the sample set, as described herein with respect to a QBM. Minimization of the loss function may include iteratively updating the value of the at least one Hamiltonian parameter based on acts of method 300 or method 400, where f(x) may be the loss function and x may be the at least one optimizable Hamiltonian parameter.

In some implementations, a value of a perturbation parameter can be a product of a normalized perturbation strength and an array of random directions (i.e., cₜ*Δ). The array of random directions can be determined according to act 310 of method 300, in which the elements of array bare samples obtained from the analog processor, and the normalized perturbation strength can be determined according to act 312 of method 300.

Estimation of a gradient of the objective function using the perturbation parameter can include performance of two evaluations of the objective function, and determination of a rate of change between the two objective function values. A first objective function value can be an evaluation of the objective function at the current value of the at least one optimizable parameter perturbed by the perturbation parameter in a first direction (i.e., f(xₜ+cₜ+Δ)). A second objective function value can be an evaluation of the objective function at the current value of the at least one optimizable parameter perturbed by the perturbation parameter in a second direction (i.e., f(xₜ−cₜ*Δ)).

Optimization of the at least one optimizable value can also include: determination of a first order moment and a second order moment using the gradient of the objective function, such as by acts 316-318 of method 300 or act 410 of method 400; and, determination of an updated value of the at least one optimizable parameter of the training model based on the first order moment and the second order moment, such as by act 320 of method 300 or act 412 of method 400.

In an example, a log-likelihood function of a transverse Ising model can be an objective function of the training model. At act 612, the training model can optimize a value of at least one Hamiltonian parameter by minimization of the log-likelihood function, which can be achieved, in part, by estimation of the gradient of the log-likelihood function using a value of a perturbation parameter determined based on samples from the analog processor.

At 614, the training model is returned to the machine learning model with an optimized value of the at least one optimizable parameter.

In some implementations, the returned training model may provide a mathematical representation of a relationship between features of the data and/or a mathematical representation of the relationship between features of the data and a target output of the machine learning model. The returned training model can be used by the machine learning model to predict outputs of data outside of the training set.

In some implementations, objective function optimizer 512 optimizes a value of the at least one optimizable parameter, for instance, of f(x) that corresponds to a parameter of quantum processor 508, as part of a training model. Once digital processor 504 determines that the value of the at least one optimizable parameter has been optimized, the training model is returned to memory in, or associated with, machine learning subsystem 510 for deployment as part of a larger machine learning model, network, or architecture.

In some implementations, the training model may be a trained QBM having optimized values of one or more Hamiltonian parameters. In some implementations, the trained QBM is returned to computing system 100, and may be stored in memory 122. When deployed, digital processor(s) 106 may execute the machine learning model, such as a QBM or QVAE, having the optimized values found during the training of the returned QBM.

In some implementations, there may be a non-transitory computer-readable medium storing instructions that, when executed by at least one digital processor, causes the at least one digital processor to perform method 600.

### Training Generative Models

A generative model statistically estimates a probability of observing real data X={x₁, x₂, . . . , xₙ}. The generative model seeks to mimic a probability distribution of X by learning the general features shared by samples of X. A generative model generates outputs that each comprise a feature set based on the learned probability distribution of features of X. The outputs are not samples of data X, but entirely new samples that have been generated from a distribution estimating the distribution of X.

In some implementations, a generative model can include a neural network (NN), which once trained is a deterministic model. Each NN may be one of: a convolution neural network, a multilayer perceptron network, a fully convolutional deep learning network, and a transformer deep learning network devoid of convolution-deconvolution layers. Training of some generative models, such as Boltzmann machines, QBMs, VAEs, and QVAEs as described herein, may include computation of gradients or a conditional marginal distribution, which cannot be achieved without the ability to easily and predictably obtain probabilities and conditional distributions.

Generative models trained using method 300 of FIG. 3 and/or method 400 of FIG. 4 can result in models that may be able to produce high-quality solutions to optimization problems and/or may have quick convergence times. Training generative models using a quantum-classical computing system may make it possible to solve complex problems more quickly than with a classical computer alone, and may enable solving problems that exceed the limitations of a classical computer.

A generative model trained using method 300 and/or method 400 can be a generative model used within a generative adversarial network (GAN), which can be used to model the joint probability distribution P (X,Y) on a given observable variable X and target variable Y, i.e., P (Y|X=x). Given a set of training data, a GAN can generate new data with the same statistics as the training set. A GAN consists of two dynamically updated neural networks: a Generative network represented by a function G, which generates candidate data by capturing a data distribution of interest; and, a Discriminator network represented by a function D, which aims to distinguish candidate data generated by G from a true data distribution, such as a distribution from which measured data has been drawn.

A generative model trained using method 300 and/or method 400 can be a generative model used within an Associative Adversarial Network (AAN), which, in addition to the Generator and Discriminator models of a GAN, also includes an associative memory network acting as a higher-level associative memory that learns high-level features generated by D. The associative memory network, represented by a function p, samples its underlying probability distribution. G then uses the samples output by p as an input, and learns to map the samples to its data space.

In some implementations, a generative model can be trained based on method 300 and/or method 400 using a quantum-classical computing system including a quantum processor, such as quantum processor 126, 200, or 506, which samples plurality of qubits 514 during annealing in the quantum coherent regime when plurality of qubits 514 exhibit non-equilibrium dynamics.

In the coherent regime, qubits in a quantum processor maintain respective qubit states, and may have dynamics that closely resemble those of a classical harmonic oscillator. During quantum annealing, qubits in the quantum processor may only exist in the coherent regime for a limited amount of time.

Samples from the quantum processor that allow for the gradient estimation log-likelihood of the transverse Ising Hamiltonian described previously herein can be obtained when the qubits of the quantum processor have equilibrium dynamics. This is because performing open system annealing includes following a quasistatic evolution with a distribution at equilibrium described by: ρ=Z⁻¹ e^{-βH(s)} where β=(k_{b}T)⁻¹. Here, k, is the Boltzmann constant, T is a temperature of the system, and s is an annealing schedule of the quantum processor. This distribution is followed until a time at which the qubits dynamics become too slow to establish equilibrium, and such a deviation results in a freeze in dynamics. If the slow-down and freeze-out of the quantum dynamics occurs within a short period of time during annealing, a final distribution at a single point (i.e., a freeze-out time) may provide approximate samples from a Boltzmann distribution corresponding to a Hamiltonian at that same point (see: Amin, Mohammad H., et al. ““Quantum Boltzmann machine”” Physical Review X 8.2 (2018): 021050).

Sampling qubits within a short period of time where qubit dynamics slow down and freeze can include obtaining measurements during a portion of an annealing schedule when qubit tunneling amplitude 4 is finite. One approach to implement such sampling is to have a two-part annealing schedule with two rates, in which a second rate exceeds a first rate. The first rate can be slow enough to guarantee equilibrium distribution, and the second rate can be fast enough that all transition channels freeze, and the thermal distribution is unaffected. A detailed description of sampling a quantum processor at a time when qubits exhibit equilibrium dynamics can be found in U.S. Pat. No. 11,062,227.

While sampling when the quantum processor maintains equilibrium dynamics includes use of non-trivial annealing schedules, it reliably provides samples that approximate the Boltzmann distribution that is used as part of training a generative network. Conversely, the probability of observing the states of qubits in the quantum processor might not be described by a Boltzmann distribution when qubits in the quantum processor do not exhibit equilibrium dynamics and the equilibrium assumption does not hold. When hardware of a quantum processor does not hold the equilibrium assumption, the probability density of finding the qubits in the quantum processor in a given state, when measured, is proportional to the squared amplitude of the wavefunction of the qubits at that state.

Training a generative model may include generation of samples for use in a training model from a quantum processor that are obtained when the equilibrium assumption does not hold. Performance of sampling while qubits are in the coherent regime and also exhibit non-equilibrium dynamics beneficially enables samples to be obtained that describe state information of the coherent qubits, but do not have the predictable distribution found when equilibrium dynamics apply. In such an implementation, samples can be obtained during quantum annealing when qubits are coherent and equilibrium dynamics are not established. When obtaining samples, there may be no freeze-out point at which the qubit states have a population close to a Boltzmann distribution, such that use of method 600 of FIG. 6 to train a QBM might not apply. Non-equilibrium qubit dynamics in the coherent regime are difficult to simulate but still include quantum correlation among samples. For these reasons, quantum processor-generated samples for which equilibrium dynamics do not apply may be preferable in some applications.

In some implementations, method 600 can be used to train a quantum-classical generative model. At acts 608 and 610, a quantum processor, such as quantum processor 126 or 508, can be used to obtain samples when qubits exhibit non-equilibrium dynamics and have a non-Boltzmann distribution. These samples can be used in the optimization of the at least one optimizable parameter at act 612.

In some implementations, method 400 can be used to optimize an objective function for use in training a generative model. At act 404 the quantum processor can be instructed to generate samples and perform readout when its qubits exhibit non-equilibrium dynamics, such that the set of samples received at act 406 can be states of qubits in the coherent regime and can have a non-Boltzmann distribution. The coherent, non-equilibrium samples can be used in the gradient estimation at act 408 to determine a value of at least one optimizable parameter.

In some implementations, the training model of the generative model may be expressed as a Hamiltonian, and at least one optimizable parameter may include at least one Hamiltonian parameters θ∈{hₐ, Jₐ). In some implementations, parameters such as: edge gain, offset values, and biases may be optimizable using the optimization techniques of methods 400 and 600. Hamiltonian parameters that are challenging to optimize may be optimized using methods 400 and 600 due to their “black box” nature, as mathematical formulae for determining parameter values are not needed for the gradient estimation techniques described herein.

### Efficient Optimization in Solving Constrained Quadratic Equations.

In another application, solving a constrained quadratic equation (CQM) can optionally include method 300 or method 400 to optimize an objective function. A detailed description of using a quantum computer to find solutions to CQMs can be found in International Patent Application PCT/US22/22596 (published as WO 2022/219399).

Use of method 300 or method 400 in a CQM solver may be advantageous in implementations in which an objective function of a problem has gradients that are difficult to estimate.

Though optimization using method 300 or method 400 has been described in the contexts of training a QBM and for finding solutions using a CQM solver, these are only examples and are not intended to be limiting. Optimization using method 300 or method 400 can be included as part of any suitable machine learning algorithm implemented by a digital processor or a hybrid computing system that comprises a digital processor and a quantum processor.

### Post-Amble

The above described method(s), process(es), or technique(s) could be implemented by a series of processor readable instructions stored on one or more non-transitory processor-readable media. Some examples of the above described method(s), process(es), or technique(s) method are performed in part by a specialized device such as an adiabatic quantum computer or a quantum annealer or a system to program or otherwise control operation of an adiabatic quantum computer or a quantum annealer, for instance a computer that includes at least one digital processor. The above described method(s), process(es), or technique(s) may include various acts, though those of skill in the art will appreciate that in alternative examples certain acts may be omitted and/or additional acts may be added. Those of skill in the art will appreciate that the illustrated order of the acts is shown for example purposes only and may change in alternative examples. Some of the example acts or operations of the above described method(s), process(es), or technique(s) are performed iteratively. Some acts of the above described method(s), process(es), or technique(s) can be performed during each iteration, after a plurality of iterations, or at the end of all the iterations.

The above description of illustrated implementations, including what is described in the Abstract, is not intended to be exhaustive or to limit the implementations to the precise forms disclosed. Although specific implementations of and examples are described herein for illustrative purposes, various equivalent modifications can be made without departing from the spirit and scope of the disclosure, as will be recognized by those skilled in the relevant art. The teachings provided herein of the various implementations can be applied to other methods of quantum computation, not necessarily the example methods for quantum computation generally described above.

The various implementations described above can be combined to provide further implementations. All of the commonly assigned US patent application publications, US patent applications, foreign patents, and foreign patent applications referred to in this specification and/or listed in the Application Data Sheet are incorporated herein by reference, in their entirety, including but not limited to: U.S. Pat. Nos. 7,533,068; 7,135,701; 7,418,283; 8,008,942; 8,190,548; 8,195,596; 8,421,053; 8,854,074; 9,424,526; 11,410,067; and, 11,062,227; US Patent Application Publications No. 2020/0401916 and, 2021/0248606; U.S. patent application Ser. No. 18/113,735; and, International Patent Application Publication Nos. WO 2022/219399 and WO 2023/114811.

These and other changes can be made to the implementations in light of the above-detailed description. In general, in the following claims, the terms used should not be construed to limit the claims to the specific implementations disclosed in the specification and the claims, but should be construed to include all possible implementations along with the full scope of equivalents to which such claims are entitled. Accordingly, the claims are not limited by the disclosure.

1. A method to optimize one or more optimizable parameters of a model, the method performed by at least one digital processor communicatively coupled to a quantum processor and comprising:
initializing, by the at least one digital processor, a set of parameters including the one or more optimizable parameters and an objective function; and,
until the objective function converges:
receiving, by the at least one digital processor, a set of samples from a probability distribution generated by the quantum processor,
estimating, by the at least one digital processor, a gradient of the objective function based on a current value of the at least one optimizable parameter and the set of samples from the probability distribution generated by the quantum processor,
determining, by the at least one digital processor, first and second order moments based on the estimated gradient,
updating, by the at least one digital processor, the one or more optimizable parameters based on the first and the second order moments, and,
evaluating, by the at least one digital processor, the objective function using updated values of the one or more optimizable parameters.

2. The method of claim 1, wherein estimating the gradient based on the current value of the at least one optimizable parameter and the set of samples from the probability distribution generated by the quantum processor comprises:
generating an array of random directions based on the set of samples generated from the probability distribution by the quantum processor; and,
estimating the gradient based on the current value of the at least one optimizable parameter and the array of random directions.

3. The method of claim 1, wherein estimating the gradient based on the current value of the at least one optimizable parameter and the set of samples from the probability distribution generated by the quantum processor comprises:
evaluating the objective function with the current value of the at least one optimizable parameter perturbed by a perturbation parameter in a first direction to obtain a first objective function value;
evaluating the objective function with the current value of the at least one optimizable parameter perturbed by the perturbation parameter in a second direction that opposes the first direction to obtain a second objective function value; and,
determining a rate of change between the first and the second objective function values.

4. The method of claim 3, wherein evaluating the objective function with the current value of the at least one optimizable parameter perturbed by the perturbation parameter comprises: determining the perturbation parameter based on a normalized perturbation strength and the set of samples from the probability distribution generated by the quantum processor.

5. The method of claim 4, wherein:
initializing the set of parameters comprises receiving an initial perturbation strength; and,
determining the perturbation parameter based on the normalized perturbation strength and the set of samples from the probability distribution generated by the quantum processor comprises: determining the normalized perturbation strength based on the initial perturbation strength and a current perturbation strength decay.

6. The method of claim 1, wherein, prior to receiving, by the at least one digital processor, a set of samples from a probability distribution generated by the quantum processor, the method comprises: instructing the quantum processor to generate the set of samples from the probability distribution.

7. The method of claim 6, wherein:
the quantum processor comprises a plurality of qubits;
instructing the quantum processor to generate the set of samples from the probability distribution comprises:
programming the quantum processor to have the probability distribution over the plurality of qubits, and
instructing the quantum processor to perform quantum evolution using the plurality of qubits; and,
receiving, by the at least one digital processor, the set of samples from the probability distribution generated by the quantum processor comprises: receiving a set of states of the plurality of qubits observable after quantum evolution that correspond to samples from the probability distribution.

8. The method of claim 1, wherein receiving, by the at least one digital processor, the set of samples from the probability distribution generated by the quantum processor comprises: receiving a set of samples from a symmetric, zero mean probability distribution that satisfies an inverse moment bound.

9. A method to train a machine learning model, the method performed by at least one digital processor communicatively coupled to a quantum processor and comprising:
receiving, by the at least one digital processor, a training data set;
generating, by the at least one digital processor, a training model associated with the machine learning model, the training model having an objective function;
initializing, by the at least one digital processor, training model parameters, the training model parameters including at least one optimizable parameter of the machine learning model;
receiving, from the quantum processor, a set of samples from a probability distribution generated by the quantum processor;
using the training model, by the at least one digital processor, to optimize the at least one optimizable parameter of the machine learning model, wherein using the training model includes estimation of a gradient of the objective function using a current value of the at least one optimizable parameter and a perturbation parameter based on the set of samples generated by the quantum processor; and,
returning, to the machine learning model, the training model with an optimized value of the at least one optimizable parameter.

10. The method of claim 9, wherein using the training model to optimize the at least one optimizable parameter of the machine learning model further comprises:
determining a first order moment and a second order moment using the gradient of the objective function that is estimated based on the set of samples from the probability distribution generated by the quantum processor;
determining an updated value of the at least one optimizable parameter of the training model based on the first order moment and the second order moment; and,
evaluating the objective function using the updated value of the at least one optimizable parameter,
wherein returning, to the machine learning model, the training model with the optimized value of the at least one optimizable parameter includes: returning the updated value of the at least one optimizable parameter once the objective function converges.

11. The method of claim 9, wherein estimation of the gradient of the objective function based on the current value of the at least one optimizable parameter and the perturbation parameter based on the set of samples generated by the quantum processor comprises:
evaluating the objective function with the current value of the at least one optimizable parameter perturbed by the perturbation parameter in a first direction to obtain a first objective function value;
evaluating the objective function with the current value of the at least one optimizable parameter perturbed the perturbation parameter in a second direction that opposes the first direction to obtain a second objective function value; and,
determining a rate of change between the first and the second objective function values.

12. The method of claim 9, wherein using the training model to optimize the at least one optimizable parameter of the machine learning model comprises: determining a value of the perturbation parameter, the determining the value of the perturbation parameter including:
generating an array of random directions using the set of samples generated by the quantum processor as an array of random binary variables; and,
determining a normalized perturbation strength,
wherein the perturbation parameter is a product of the array of random directions and the normalized perturbation strength.

13. The method of claim 9, wherein generating the training model associated with the machine learning model includes: generating at least a training model associated with a generative machine learning model.

14. The method of claim 9, wherein generating the training model comprises: generating a quantum Boltzmann machine.

15. The method of claim 9, wherein: generating the training model comprises generating a model described by a transverse Ising Hamiltonian, and the at least one optimizable parameter comprises at least one Hamiltonian parameter.

16. The method of claim 9, wherein the objective function is a loss function, and using the training model to optimize the at least one optimizable parameter of the machine learning model comprises:
minimizing the loss function describing a difference between data belonging to the training data set and the set of samples generated by the quantum processor, and
estimating a gradient of the objective function comprises estimating a gradient of the loss function.

17. The method of claim 9, wherein prior to receiving, by the at least one digital processor, the set of samples from the probability distribution generated by the quantum processor, the method comprises: instructing the quantum processor to generate the set of samples from the probability distribution.

18. The method of claim 17, wherein:
the quantum processor comprises a plurality of qubits;
instructing the quantum processor to generate the set of samples from the probability distribution comprises:
programming the quantum processor to have the probability distribution over the plurality of qubits, and
instructing the quantum processor to perform quantum evolution using the plurality of qubits; and,
receiving, by the at least one digital processor, the set of samples having the probability distribution generated by the quantum processor comprises: receiving a set of states of the plurality of qubits observable after quantum evolution that correspond to samples from the probability distribution.

19. The method of claim 9, wherein receiving, from the quantum processor, a set of samples from a probability distribution generated by the quantum processor comprises: receiving, from the quantum processor, samples from a symmetric, zero mean probability distribution that satisfies an inverse moment bound.

20. The method of claim 9, wherein receiving, from the quantum processor, a set of samples from a probability distribution generated by the quantum processor comprises: receiving samples obtained in a coherent regime when the quantum processor exhibits non-equilibrium dynamics.

21. A system to perform machine learning, the system comprising:
a quantum processor;
at least one digital processor communicatively coupled to the quantum processor; and,
at least one non-transitory processor-readable medium communicatively coupled to the at least one digital processor, the at least one non-transitory processor-readable medium store at least one of processor-executable instructions or data which, when executed by the at least one digital processor, cause the at least one digital processor to:
initialize a set of parameters, including one or more optimizable parameters and an objective function; and,
until the objective function converges:
receive, by the at least one digital processor, a set of samples from a probability distribution generated by the quantum processor,
estimate, by the at least one digital processor, a gradient of the objective function based on a current value of the at least one optimizable parameter and the set of samples from the probability distribution generated by the quantum processor,
determine, by the at least one digital processor, first and second order moments based on the estimated gradient,
evaluate, by the at least one digital processor, the objective function using updated values of the one or more optimizable parameters, and
update, by the at least one digital processor, the one or more optimizable parameters based on the first and the second order moments.

22. The system of claim 21, wherein the quantum processor comprises a plurality of qubits.

23. The system of claim 22, wherein each sample of the set of samples is a set of states of the plurality of qubits of the quantum processor.

24. The system of claim 21, wherein the quantum processor is a quantum annealer or an adiabatic quantum processor.

25. The system of claim 21, wherein, the gradient is based on the current value of the at least one optimizable parameter and an array of random directions, wherein the array of random directions is based on the set of samples generated by the quantum processor.

26. The system of claim 21, wherein:
the gradient is based on a rate of change between a first objective function value and a second objective function value;
the first objective function value is an evaluation of the objective function at the current value of the at least one optimizable parameter perturbed by a perturbation parameter in a first direction; and,
the second objective function value is an evaluation of the objective function at the current value of the at least one optimizable parameter perturbed by the perturbation parameter in a second direction that opposes the first direction.

27. The system of claim 26, wherein the perturbation parameter is based on a normalized perturbation strength and the set of samples generated by the quantum processor.

28. The system of claim 27, wherein the normalized perturbation strength is based on a perturbation strength and a current perturbation strength decay.

29. The system of claim 21, wherein the set of samples generated by the quantum processor are samples from a symmetric, zero mean probability distribution that satisfies an inverse moment bound.

30. The system of claim 21, wherein the set of samples generated by the quantum processor are samples obtained when the quantum processor exhibits non-equilibrium dynamics in a coherent regime.

31. The system of claim 21, wherein prior to receipt of the set of samples from the quantum processor, the at least one digital processor is to instruct the quantum processor to generate the set of samples from the probability distribution.

32. A system to perform machine learning, the system comprising:
a quantum processor;
at least one digital processor communicatively coupled to the quantum processor; and,
at least one non-transitory processor-readable medium communicatively coupled to the at least one digital processor, the at least one non-transitory processor-readable medium store at least one of processor-executable instructions or data which, when executed by the at least one digital processor, cause the at least one digital processor to:
receive a training data set,
generate a training model associated with the machine learning model, the training model having an objective function,
initialize training model parameters, the training model parameters including at least one optimizable parameter of the machine learning model,
receive, from the quantum processor, a set of samples from a probability distribution generated by the quantum processor,
use the training model to optimize the at least one optimizable parameter of the machine learning model, wherein using the training model includes estimation of a gradient of the objective function using a current value of the at least one optimizable parameter and a perturbation parameter based on the set of samples generated by the quantum processor, and,
return, to the machine learning model, the training model with an optimized value of the at least one optimizable parameter.
